(19) United States
(12) Patent Application Publication
(10) Pub. No.: US 2025/0021792 A1
(43) Pub. Date: Jan. 16, 2025

(54) SYSTEM AND METHOD FOR A PERSONALIZED SEARCH AND DISCOVERY ENGINE

(71) Applicant: Miso Technologies Inc., San Francisco, CA (US)

(72) Inventors: Cheng-Kang Hsieh, Mountain View, CA (US); Lasantha Lucky Gunasekara, Cambridge, MA (US); Chih-Ming Chen, New Taipei City (TW)

(21) Appl. No.: 18/746,167

(22) Filed: Jun. 18, 2024

Related U.S. Application Data
(63) Continuation of application No. 17/116,565, filed on Dec. 9, 2020.

(51) Int. Cl. G06N 3/042; G06F 16/2457; G06N 3/045; G06N 3/08

(52) U.S. Cl. CPC G06N 3/042; G06F 16/24578; G06N 3/045; G06N 3/08

(57) ABSTRACT

A system and method for a content-centric personalized recommendation engine that includes processing user data comprised of user feature data as input to a user neural network model and yielding a user embedding; processing the user embedding through a matchmaking neural network, which is a trained model to map user embeddings and content embeddings to a shared dimensional space, and yielding a user shared-item embedding; and applying analysis of the user shared-item embedding in selecting at least one content item associated with a content shared-item embedding within the matchmaking neural network.

### CROSS-REFERENCE TO RELATED APPLICATIONS

This Application is a Continuation Application of U.S. patent application Ser. No. 17/116,565, filed on 9 Dec. 2020, which claims the benefit of U.S. Provisional Application No. 62/945,791, filed on 9 Dec. 2019, both of which are incorporated in their entirety by this reference.

### TECHNICAL FIELD

This invention relates generally to the field of digital search and discovery and more specifically to a new and useful system and method for content-centric personalized recommendations and queries.

### BACKGROUND

Since the advent of the internet, the availability of information and media of all stripes (audio, video, photos, and documents) has increased by orders of magnitude to astounding and rather incomprehensible amounts. Search engines were developed to bring some order and accessibility to this vast body of information, with discovery engines intended to sift through all of this content and make astute recommendations to users. In essence, search engines are intended to help users find what they were looking for and discovery engines are meant to surface content they didn't even know they were interested in until they see the content.

Although search engines have improved significantly since their advent, the basic framework has stayed fairly consistent as a mix of crawling, indexing, and searching. Additionally, implementation of a quality search engine with high relevancy to users over large corpora of information and content has been so complex it has mostly been limited to key providers offering generic search of the web. Site-search and internal content or product recommendation for the average website or application tends to be generic and keyword based. Many such systems are also highly driven by rules that are written and managed by human workers responsible for the management of a given online website, application or service. Likewise, quality search of isolated internal and private bodies of content, which may sometimes be private, faces many barriers to implementation towards high relevancy. In many cases, search tools of even popular ecommerce or content websites are highly constrained by the lower relative volume of data that falls below the requisite threshold for contemporary personalization methods.

Beyond search engines, existing systems apply user-to-user learning and profiling to provide personalized recommendations. For example, viewing behavior of a user may be used to recommend other content based on people with similar viewing patterns. The means to learn and track these preferences increasingly extend well beyond just user behavior on the application of interest to tracking users via cookies and monitoring networks across the wider web.

Other forms of personalization in a computer platform may use optimization and trend analysis techniques, such as AB and/or multivariate optimization techniques. Content optimization solutions similarly depend on a large amount of data and use of categorical segmentation to deliver content based on user-to-user similarities. This model of segmentation however does not deliver true personalization at an individual level but rather broad segments of look-alike audiences.

Such approaches depend on considerable amounts of data and as such, personalized search and recommendation systems are limited to large web-scale platforms with large numbers of users. As such personalization is practically limited to only the largest of web platforms. Often these systems are highly centralized as a result. Yet, because relevancy is driven by user profiles and user preference and behavior signals, there's a “rich get richer” network effect, known as preferential attachment. In other words, platforms for media and information search and discovery that unlock user adoption quickly can leverage the large amounts of data obtained from this for improved search and discovery that can very quickly begin to lock in users into engagement loops that not only drive their viral growth and rise but also entrench their incumbency versus upstarts.

Additionally, such solutions suffer from further limitations. Primarily, existing approaches fail to address a cold start issue of a new user to the platform or new available content. Without content history, existing solutions are limited in their effectiveness. As another limitation, many solutions are ill equipped to handle large volumes of new content or time critical content. New content or content with a short window of utility (e.g., news stories or social media posts) have little time to acquire sufficient content-user history to adequately be of use for deeper personalization.

Thus, there is a need in the field of search and discovery for a system and method that enables content-centric personalized recommendations and queries. This invention provides such a new and useful system and method.

### BRIEF DESCRIPTION OF THE FIGURES

FIG. 1 is a schematic of preferred embodiment of the system.

FIG. 2 is a schematic of a variation of the system showing API integration.

FIG. 3 is a schematic representation of content and user embeddings in a CML model.

FIG. 4 is a flowchart representation of one variation of the method.

FIG. 5 is a flowchart representation of a variation of the method using user shared-item embeddings.

FIG. 6 is a schematic representation of a variation method using user shared-item embeddings.

FIG. 7 and FIG. 8 are flowchart representations of variations of the method.

FIG. 9 is a schematic representation of a first variation of updating a CML model.

FIG. 10 is a schematic representation of a second variation of updating a CML model.

FIG. 11 is a schematic representation of a combined computational model with application-specific CML models.

FIG. 12 is a schematic representation of processing content and users into a matchmaking data model.

FIG. 13 is a flowchart representation of one variation of applying a matchmaking data model.

FIG. 14 is a schematic representation of one variation of generating a personalization score.

FIG. 15 is a schematic representation of one variation of generating a personalization score using a classifier.

FIG. 16 and FIG. 17 are flowchart representations of variations of applying a matchmaking data model.

FIG. 18 is a schematic representation of a general process of reordering a relevancy search.

FIG. 19 is a schematic representation of an exemplary set of data being reordered using tiered groupings.

FIG. 20 is a schematic representation of biasing a neural network using an artificial virtual user.

FIG. 21 is an exemplary system architecture that may be used in implementing the system and/or method.

### DESCRIPTION OF THE EMBODIMENTS

The following description of the embodiments of the invention is not intended to limit the invention to these embodiments but rather to enable a person skilled in the art to make and use this invention.

### 1. Overview

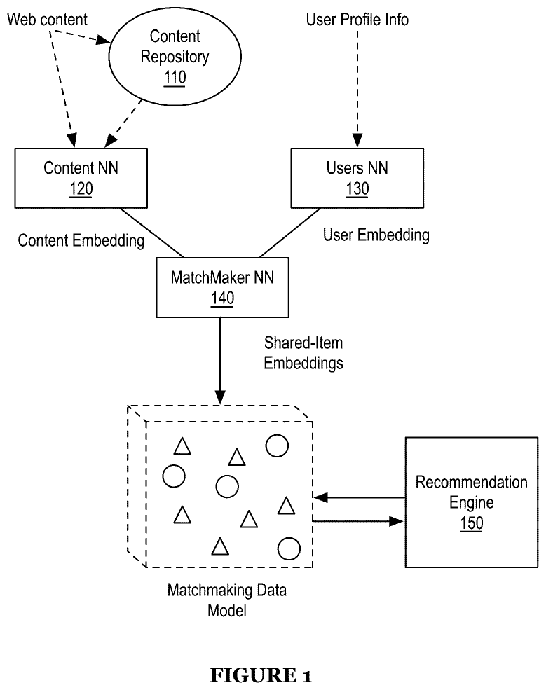

The system and method are preferably used for providing a personalized and content-centric search and discovery engine. As shown in FIG. 1, a system and method for providing content-centric predictive personalization can enable a personalization tool that can be used for search, recommendations, and/or discovery for a set of data, whether it be text information or audio-visual multimedia. The system and method can operate with small amounts of data and may provide new forms of advanced individualized (e.g., user “n=1”) predictive personalization using collaborative metric learning. In the system and method, a new user can quickly be provided with personalized search and discovery. The system and method can enable the new capability of a digital content engine to perform these operations without dependence on user-to-user modeling and without dependence on large content/user datasets. Accordingly, the system and method may provide a number of enhancements beyond current solutions that often have such limitations. In particular, the system and method can enable new capabilities of a search and recommendation engine to provide personalization to new users and new content. This may be done from a “cold start” where little to no prior data is available on a user and/or a piece of content. Furthermore, the system and method may run in real-time for progressive and responsive personalization.

Through collaborative metric learning, the system and method may be able to establish an understanding of user preferences and affinities to content and other users by using an existing user profile as a look-alike reference. This understanding is preferably an enhanced understanding, based on a set of neural networks, that can model or encode individual user and content characteristics and incorporate items in a relational hierarchy with the user characteristics, thereby enabling the system and method to provide and individualize personalization for a user.

The system and method may be used as the technical solution for implementing search, item recommendations, item suggestions, user interface autocomplete (e.g., a search typeahead interface), and/or other forms of recommendations within a digital system.

In one exemplary application, the system and method may be used in facilitating search. For example, the system and method may be used to drive a search engine of an e-commerce or media content site. The system and method may be used in enabling personalized relevancy ranking of the search results. The personalization of the relevancy ranking provided by the system and method can furthermore be customized and distinct for each user.

In another exemplary application, the system and method may be used in making recommendations. Recommendations can be used to highlight similar media content and/or similar products.

In another exemplary application, the system and method may be used in providing personalized suggestions. This can be used for personalized suggestions of content (e.g., product) combinations or sets. For example, the system and method can be used to highlight a personalized list of products that were similarly purchased with a particular item.

In another exemplary application, the system and method may be integrated with an advertising platform such that personalized advertisements can be served to a user.

In another exemplary application, the system and method may be integrated into the operation of a user interface element wherein the operation of the user interface element changes performance to incorporate personalized functionality. For example, autocompletion/typeahead suggestions in a textbox form input may be populated using personalized predictions of autocompletion options such that as a user types out their query one letter at a time, personalized autocompletion suggestions naturally populate within the user interface.

In another exemplary application, the system and method may establish a matchmaking data model (e.g., a CML data model) with which the relevancy between content and user can be calculated and used as input to other applications.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

One potential benefit of the system and method is that recommendations may be given without the need of a large quantity of data. This may reduce both the amount of processing power and space that is needed to provide information. Furthermore, the search, discovery, and recommendation features of the system and method can more quickly and more widely be used in use cases that had previously lacked sufficient data to provide such features reliably. Many websites lack billions or even millions of users, preventing potential use of traditional big data approaches, but the system and method may be used with such websites.

Additionally, the system and method can be effective for new content and/or new users. The system and method may not require that new content and/or new user data be trained-on prior to being included in query search and predictions. Using collaborative metric learning, information about new data may be predicted and the new data may be appropriately be mapped onto a recommendation vector space. For example, a new movie added to a movie database may not have any existing viewing history but could be incorporated into personalized recommendations for appropriate users through the conceptual mapping of content as used in the system and method.

As a related benefit of the system and method is immediate incorporation of new data. Without the need to “train” the data, the data may be directly mapped and utilized. This potential benefit can impact new users or newly obtained information of a user. For example, new users can immediately have personalization. Without the requirement to previously cluster the user and the user data with similar users through learning, the user may immediately receive highly relevant personalization. In essence, users can receive increasingly better personalization in real-time with each successive interaction with the information retrieved or recommended. In this way, the system and method enable a process for discrete interaction personalization where an individual interaction or a small set of interactions can be used to generate highly personalized assessments. While usable with small amounts of data, the system and method are not limited to small datasets and can be scaled to systems with large datasets.

Furthermore, the system and method can alleviate dependence on large amounts of user data and records of past content interactions. The system and method therefore may offer user privacy advantages over other existing techniques. Another potential benefit of the system and method is that the system and method may be highly flexible for the types of content for which it is used. The system and method may be used across a wide variety of different types of content with varying degrees of information. The system and method may be used with content that is text-based, audio, photographic/graphical, and/or video. The system and method may additionally or alternatively be used for other alternative forms of media such as interactive media content, specialized media content, and the like. In some variations, the system and method may be used for multiple media formats. In many ways, the system and method can be agnostic to the type of content. That is, the system and method can be usable for a wide variety of content mediums.

The system and method can preferably be applied within digital computing systems that make use of personalization for digital interactions relating to content discovery and recommendation, search, content delivery, advertisement, content creation/customization, and/or other suitable applications.

The system and method are preferably implemented to give personalized recommendations. Recommendations may be of any type that is relevant to a user. Examples may include recommending articles, music, movies, webpages, products, and the like. Additionally, the system and method may enable highly personalized searches based on an input query. The system and method may also be used to provide predictive content in the form of passive but high engagement interaction models such as personalized feeds for users to scroll through, personalized playlists of infinite content, personalization of user interface (e.g., personalized categorical filtering on search results), and/or personalized predictive typeahead search. As another example, the system and method may achieve customized personalization of content suggestions such as a personalized presentation of product deals or discounts. The system and method may simulate content in the recommendation space for a user, and provide recommendations based on these simulations. In one example, the system and method may facilitate generating a report on the simulations.

### 2. System

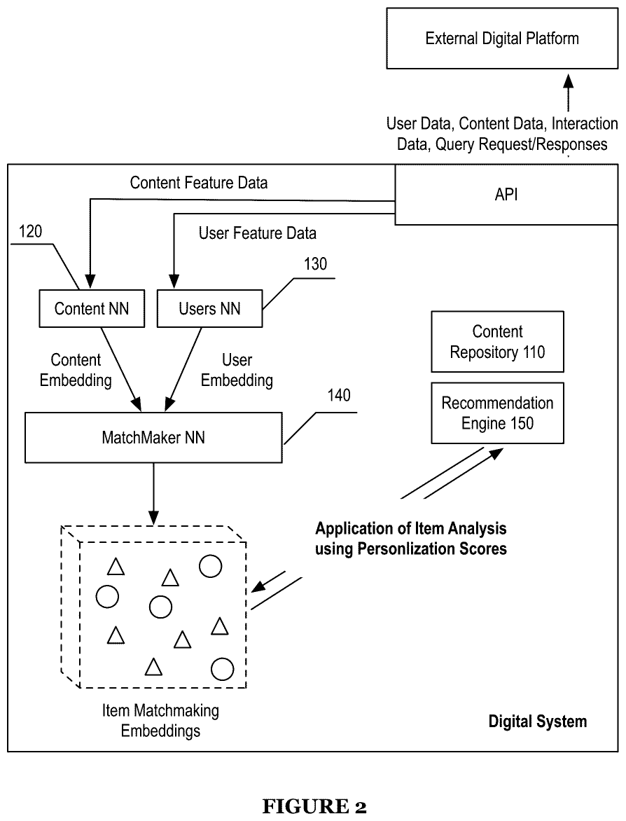

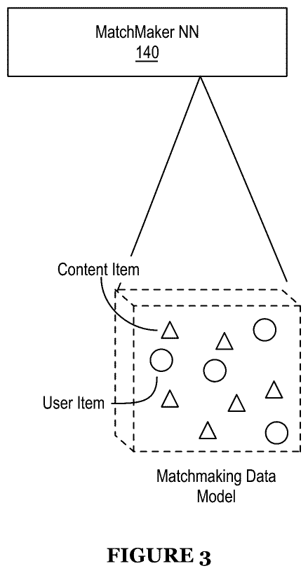

As shown in FIG. 1, a system that provides predictive personalization comprises: a content repository 110, content neural network 120, a user neural network 130, and a matchmaking neural network 140 that combines data from the content neural network 120 and the user neural network. The system functions to provide personalization recommendations through the neural network models. The matchmaking neural network 140 is a vector space mapping wherein the distance between a user/subject, and contents/objects show the relevance of the content for the user, as shown in FIG. 3. The system preferably includes a recommendation engine 150 implemented as computer-readable mediums configured with instructions and one or more processors, wherein processing of the instructions cause the one or more processors to perform operations related to the training and/or processing of items (e.g., user or content data) as part of generating a recommendation. In some variations, the system can include an application programming interface (API) wherein programmatic requests can be received and replied to for purposes of populating and updating the components of the system (e.g., uploading content data, user data, interaction logs) and/or for fulfilling recommendation queries and requests as shown in FIG. 2.

A content repository 110 of a preferred embodiment functions to store data for the system. The content repository 110 may contain data that has been, or will be, analyzed by the system. The content repository 110 may interface with one or more external data sources. The content repository 110 or the system in general may include one or more computer executed services that can facilitate interfacing with a data source. In some variations, the content repository 110 may be populated from data from a data source looking to make use of the system. For example, an ecommerce website may upload product related data or a content website may upload content related data to the content repository 110. Alternatively or additionally, data of the content repository 110 may be populated in part from actively retrieving the data from one or more external data sources (such as through crawling a site).

Such services may include services for interfacing through an application programming interface (API) and/or crawling. In one example, a web scraper can be used in obtaining data from the internet. Additionally or alternatively, the content repository 110 may have a collection of data directly loaded into the content repository 110. As another variation, data may be loaded using an external content/user data service, a direct integration with a website's content management system (CMS), or another form of data integration. The content repository 110 may alternatively obtain data through any suitable approach.

A content neural network 120 (C-NN) of a preferred embodiment functions as a neural network model of items that constitutes an incorporation and mapping of data items (i.e., content) in relation to each other. The C-NN 120 may be a feedforward neural network, a regulatory feedback network, a radial basis function network, a recurrent neural network, a modular neural network, or any other type or combination of types of neural networks. The C-NN 120 preferably includes functionality to update and improve item-item similarity through feedback from the system and from outside the system.

C-NN items may be of a specific data type (e.g., audio items, text times, video items, photo/graphical items). Alternatively, C-NN items may be of multiple, different content types. In one preferred variation the C-NN 120 is content agnostic; that is, the C-NN 120 can incorporate items together regardless of the item data type. As one example, a website may have media content (e.g., articles discussing products) and product content that can be processed through a C-NN and added to the MmNN 140. In some instances, different types of content may be processed through separate content processing pipelines (e.g., using one product C-NN model for products and an article C-NN model for article content). Alternatively, a generalized C-NN may be used for multiple content types. In a second variation, the C-NN 120 is optimized to incorporate a specific data type. In a third variation, the C-NN 120 may have regions that are data type specific and regions that are data type agnostic. In a fourth variation, the C-NN 120 may utilize item data type as one metric for mapping item-item similarity.

The C-NN 120 system may function to allow for an enriched model of the content that goes well beyond the limitations of traditional metadata systems. For example, the C-NN 120 can process the actual semantic information embedded within a piece of photo media to identify key objects within, the mood of the photo and if there are key actions. In another example, the C-NN 120 may be able to similarly encode text media to identify important concepts and keywords. A transformer, encoder model, or other process with pre-trained understanding of terms and concepts may be used to enrich the content embeddings. This capability may overcome critical gaps and shortcomings in content metadata such as tags or annotations, which usually rely on large amounts of manual human input and editorial curation.

In one preferred variation, the C-NN 120 can include, integrate with, or in some variations be a concept-to-vector deep learning model that functions to identify and map concepts from content items. A C2V model can preferably be pre-trained to map content to a multi-dimensional vector space representing conceptual relationships. The C2V model preferably accepts content (likely converted to a set of content features) and outputs a concept-related embedding vector. The C2V model may function as a “knowledge base” metric used to analyze new data. The C2V model may thus function to bootstrap understanding to new data, enabling learning of new concepts from the new data in relation to the C2V model. The C2V model is preferably a high dimensional vector space.

The C2V model can potentially be configured for one or more types of media. Additionally, multiple C2V models can be operated by the system for different types of media, classes of media, for different uses of media or intended actions. In the variation where two or more C2V models are maintained for different actions, each C2V model may map content to a concept vector space that corresponds to concept similarities for that intended action. A different C2V model may be used for different actions such as recommendations, search, advertising, and the like. For example, a C2V mapping content for recommendations may be different for search compared to a C2V for recommendations.

The system may include one or more content item processing engines. Exemplary content item processing engines can include a natural language processing (NLP) system, a computer vision processing system (e.g., image and/or video processing), audio processing system, and/or any suitable media processing system. The content item processing engines preferably facilitate initially extracting feature sets from a content item, which can be used in a C2V.

In some preferred embodiments, the C-NN 120 includes a content engine. The content engine functions to ingest and/or otherwise acquire content and to process the content for training and population of the C-NN 120. In one variation, the content engine could be a web crawler. The content engine may additionally interface one or more sources of public data or otherwise collect public data. For example, various publications could have papers and articles incorporated and analyzed. The public data gatherings system can preferably dynamically discover new sources of public data. The public data gatherings system is preferably periodically or continuously operated. The public data gatherings system preferably identifies public data resources and accesses the public data for processing. In some variations, all or a portion of the public data may be saved or recorded in the content repository 110, but more preferably the public data is indexed and stored with a reference to the public data along with other suitable properties or metadata. The content engine can preferably output collected content to the C-NN 120 for training and mapping.

In some one variation, an API of the system can include a content API by which content data can be submitted to the system. The content data may be stored in a content repository 110.

The user neural network 130 (U-NN) of a preferred embodiment functions as a neural network model of users that maps users to a multidimensional vector space based on user information. The U-NN 130 may be a feedforward neural network, a regulatory feedback network, a radial basis function network, a recurrent neural network, a modular neural network, or any other type or combination of types of neural networks. The U-NN 130 preferably includes functionality to update and improve mapping of users.

A user profile feature set will preferably be input into the U-NN 130 model. The user profile feature set will generally be a characterization of a user profile. In one variation, a user profile feature set will include a set of features based around various classifications derived directly from a user profile. Additionally or alternatively, a user profile may be processed using machine learning, neural network/deep learning, statistical modeling, heuristical modeling, and/or other suitable processing.

The user profile feature set preferably includes data that enables a characterization of the user. User profile data may include personal demographic user information (e.g., user age, height, weight, race), user interests, previous content related to history of the user, social media data, information from associated users, and/or any other information that may enable any characterization of the user. In one example, a user profile may indicate a corresponding social media account of the same user, and the social media account may be used in setting the user profile feature set. A user profile content may vary depending on the context of use for the system. For example, when used within an internal employee tool, the employment title, project assignment, team assignment, experience history, and/or other job-related information may be available in a user profile.

In some preferred variations, the user profile feature set includes user profile data (if available) as well as a set of user interaction data. The user interaction data can be a set of recent interactions. Use of interaction data as part of the user feature data can enable personalization for an unknown user with only a single interaction. With each subsequent interaction (e.g., viewing content, clicking content, etc.), the personalization can be improved.

Herein the U-NN 130 is primarily described as a neural network based around users (i.e., people). However, the structure and nature of the U-NN 130 is not limited to mapping users and user data. Generally speaking, as part of the system, the U-NN 130 provides a point of query “subject” for relational mappings, enabling the system to provide predictive/suggestive “objects” from the C-NN 120 for the subject. Thus, the U-NN 130 should not be considered limited to actual users per se. The U-NN 130 could alternatively map any suitable type of subject that may interact with or relate to content. For example, instead of the user being a singular person it could be a profile of a team of people, an organization, and/or any suitable entity. Thus, as used in this document, the terms user and user data refer to subject and subject related data that a query can be based upon, and content or items refer to objects that may be part of a query response. Similarly, the user could be a device such as a gaze or gesture interactive public display device for advertising or a voice interactive speaker system in a building for playing ambient music. Additionally, subjects and objects are not necessarily disjoint concepts; that is data may be both a subject incorporated in the U-NN 130 and an object incorporated in the C-NN 120 (e.g., the system implemented in a dating/matchmaking platform may incorporate people as both subjects and objects). Similarly, there may be some system implementations or variations, where a single item-related neural network is used in place of a C-NN 120 and a U-NN 130. For example, in one variation, recommendations and relational comparisons of different media content may be performed using only a C-NN 120, in which case there may be no U-NN 130 or MmNN 140.

Analogous to the C-NN 120 content engine, in preferred variations the U-NN 130 may also have a user engine. The user engine may function to acquire and incorporate users and user data and process U-NN 130 users and user data for training and mapping. In specific cases the user engine may ingest user data from internal systems such as enterprise HR records or SSO IDs. In other cases, the user engine may access global personal lookup systems. Alternatively, the U-NN 130 may operate with the available user related data of a site. In some implementations, this can include creating a user profile for any anonymous or visitor session on a given website or application. As a result, personalization can be customized around the data and interactions of a particular session or visit.

In some one variation, an API of the system can include a user API by which user data can be submitted to the system about the user. In some cases, there may be a user API for submitting basic user profile data and an interaction API for submitting event data related to different user interactions.

The matchmaking neural network 140 (MmNN) of a preferred embodiment functions as a computational model that enhances a shared mapping of content embeddings from the C-NN 120 and user embeddings from the U-NN 130. The MmNN 140 is preferably a system that learns a joint metric space to encode user content preferences through item proximity. The embeddings of the U-NN 130 model and the C-NN 120 model are preferably mapped into a shared vector space. The MmNN 140 can preferably maintain representation in memory and performs “in silica” optimization thereby providing a number of efficiencies and potential benefits over other recommendation and search approaches.

The MmNN 140 preferably determines a shared vector space mapping for users and content items such that user-content item proximity as well as content-content item proximity and user-user item proximity in the shared space may be used in making various conclusions around similarity, differences, and relationships. The MmNN 140 preferably converts content embedding (output by the C-NN 120) or user embeddings (output by the U-NN 130) to an embedding called a shared-item embedding. A content related shared-item embedding is referred to as a content shared-item embedding. A user related shared-item embedding is referred to as a user shared-item embedding. The generated shared-item embeddings are preferably stored as part of a matchmaking data model. In this way, a shared-item embedding can be retrieved for a given content or user item.

In one preferred variation, the MmNN 140 is a collaborative metric learning (CML) model. The CML model is preferably implemented through configured collaborative filtering algorithms. The CML preferably applies observed implicit feedback to model a set of user-content item pairs S that are shown to have a positive relationship and then learns the user-content item metric to encode these relationships. The learned metric will preferably pull the pairs in S closer and push other pairs relatively further apart. This process, due to the triangle inequality, can also cluster the users who co-like the same items together, and 2) the items that are co-liked by the same users together. Through the CML, the nearest neighbor items for any given user preferably becomes: the items liked by this user previously, and the items liked by other users who share a similar taste with this user previously.

In other words, by learning a metric that obeys the known positive relationships, relationships are propagated not only to other user-item pairs, but also to user-user and item-item pairs for which relationships may not have been directly observed.

In some variations, a MmNN 140 may be trained so as to be biased towards select interactions. In one implementation, a MmNN 140 is trained on a set of users with full interaction data and a set of users with select interaction data. The select interaction data may include a subset of the interaction data, selected based on desired or targeted interactions. For example, a MmNN 140 may be trained using all customer interaction data as well as virtual users that include an add-to-purchase interaction data. This will train the MmNN 140 to have a bias towards purchase interactions. Content recommendations for a user may therefore be biased towards content that a user may purchase.

In another variation, personalization of content may not be uniform across all types of actions or interactions within a digital platform. Accordingly, the system may include a set of action-associated CMLs. The set of action-associated CMLs functions to enable a platform to have individual CMLs for providing interaction-specific personalization. Examples of action-associated CMLs may include CMLs for content click-through, bookmarks, favoriting, commenting, adding to a cart, purchasing, opening email, sharing, reading/viewing, and/or other suitable types of actions.

As mentioned, the system may be used as a mechanism for delivery of personalization in digital platform. Different instantiations of the system applied to different applications may include additional systems in actualizing the personalization.

A recommendation engine 150 of a preferred embodiment functions to facilitate the processing of a request, using the matchmaking data model output from the MmNN 140. The recommendation engine 150 may be used as part of a search engine, a content delivery engine, or user interface control system, or any suitable type of system.

In a personalized search variation, the system may include a search engine system. The search engine system preferably includes an interface to receive a user query. The search engine may additionally include a primary content search system. The primary content search system may use a variety of techniques and search tools. The primary content search system may use attributes and features such as term frequency-inverse document frequency techniques, item popularity ranking, date of items, item interaction history, and/or other search ranking approaches. The primary content search system can supply an initial result that may be then re-ranked by the matchmaking engine.

In a content delivery variation, the system may include a content delivery system. The content delivery system functions to select appropriate content based on the MmNN 140 and communicate the content to an appropriate system. In general, the content delivery system will communicate the content to a user interface. The content delivery system may be used in personalizing content presentation, serving relevant advertisements or notifications, and/or for other suitable applications. This may even extend to passive interaction models such vertical feeds, content card swiping systems or streaming media playlists or radio stations.

In a content and/or user profiling variation, the system may include a profile report generator. The profile report generator creates a digital report based on analysis of the “spatial” mapping of content and/or users within the MmNN 140. The profile report generator can preferably query and/or access the MmNN 140 on behalf of one or more pieces of content and/or users. The report may be used in a variety of tools or user interfaces for reporting and forecasting of trends in user interests over time and potentially into the future.

### 3. Method

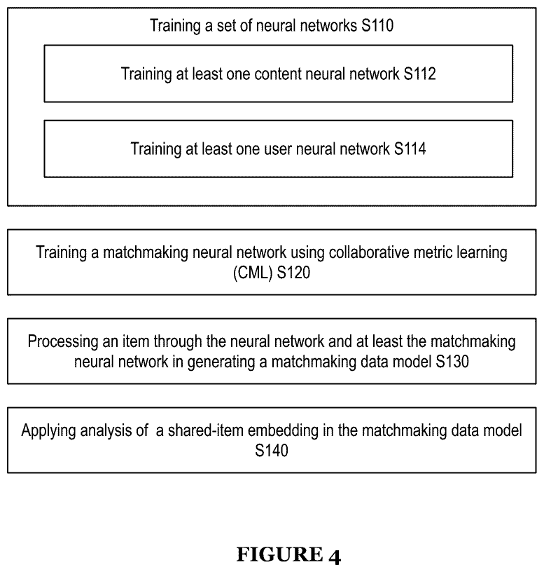

As shown in FIG. 4, a method for predictive personalization that incorporates collaborative metric learning comprises: training a set of item neural networks S110, training a matchmaking neural network using collaborative metric learning (CML) S120, processing an item through the neural network and at least the matchmaking neural network in generating a matchmaking data model S130, and applying analysis of a shared-item embedding in the matchmaking data model S140. Training a set of neural networks preferably includes training at least one content neural network S112, and training at least one user neural network S114.

The method is preferably used in mapping representations of different items into a shared-multi-dimensional space. These different items can represent items such as content and/or users as shared-item embeddings (or vectors). Accordingly, the method may be particularly useful in transforming data records, user interaction event data, and/or other data inputs into “affinity” mapped data representations of content and subjects (e.g., users) within a shared multi-dimensional space. Similarly, relevant suggestions of content and/or user items can preferably be made through a resulting matchmaking neural network data model (e.g., a CML data model) of the method.

The method may be applied or otherwise used in implementing a form of personalization or other form of content/user analysis. For example, the method can be applied in block S140 for facilitating: item recommendations; item summaries (e.g., making a user report and/or a content report); guiding advertisement/content delivery; generating personalized search results; personalized promotions, deals, or pricing offers of products; generating video or audio playlists, media feeds, or swipe-through recommendations, managing digital user interface interactions such as autocomplete of form inputs, and/or facilitating other suitable actions.

The method may be implemented in an approach that involves the generation and creation of the neural networks used to accurately model content and items within the shared multi-dimensional space. The method may alternatively be implemented in a manner that makes use of the trained or provided neural networks.

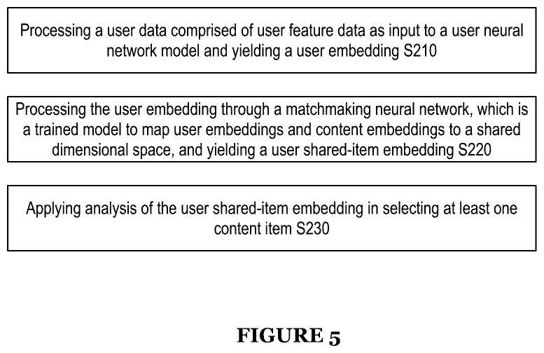

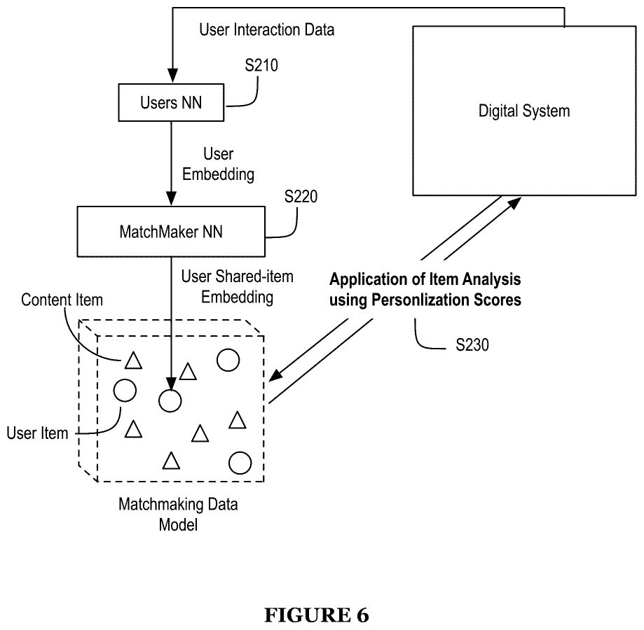

As shown in FIG. 5 a method using a matchmaking neural network can include: processing a user data comprised of user feature data as input to a user neural network model and yielding a user embedding S210; processing the user embedding through a matchmaking neural network, which is a trained model to map user embeddings and content embeddings to a shared dimensional space, and yielding a user shared-item embedding S220; and applying analysis of the user shared-item embedding in selecting at least one content item S230. This variation may make use of a provided matchmaking neural network wherein content items have been populated as content shared-item embeddings as shown in FIG. 6.

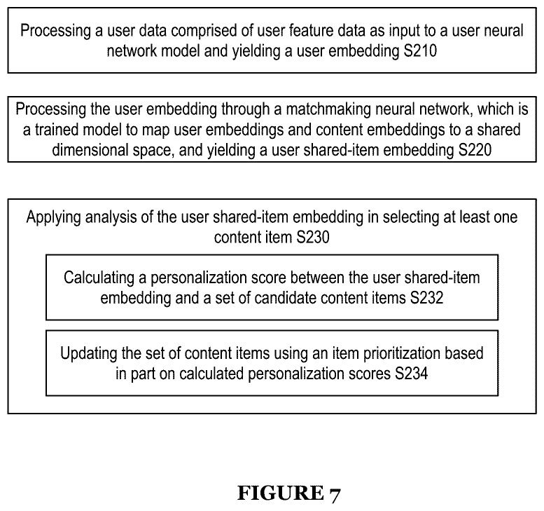

In general, a matchmaking neural network used in modeling user and content shared-item embeddings may be used in adding personalization into the selection and filtering of search results. Accordingly, as shown in FIG. 7, a method adding personalization to a query results can further include processing a user data comprised of user feature data as input to a user neural network model and yielding a user embedding S210; processing the user embedding through a matchmaking neural network, which is a trained model to map user embeddings and content embeddings to a shared dimensional space, and yielding a user shared-item embedding S220; and applying analysis of the user shared-item embedding in selecting at least one content item S230 by calculating a personalization score between the user shared-item embedding and a set of candidate content items S232 and updating the set of content items using an item prioritization based in part on calculated personalization scores S234. The personalization as used in this variation and other variations herein can serve as a signal or part of a signal for relevancy of an item to a user. This can be used across a set of candidate items to personalize relevancy across those candidate items.

As discussed herein there can be many variations in an approach for selecting content items using analysis of the user-shared-item embedding.

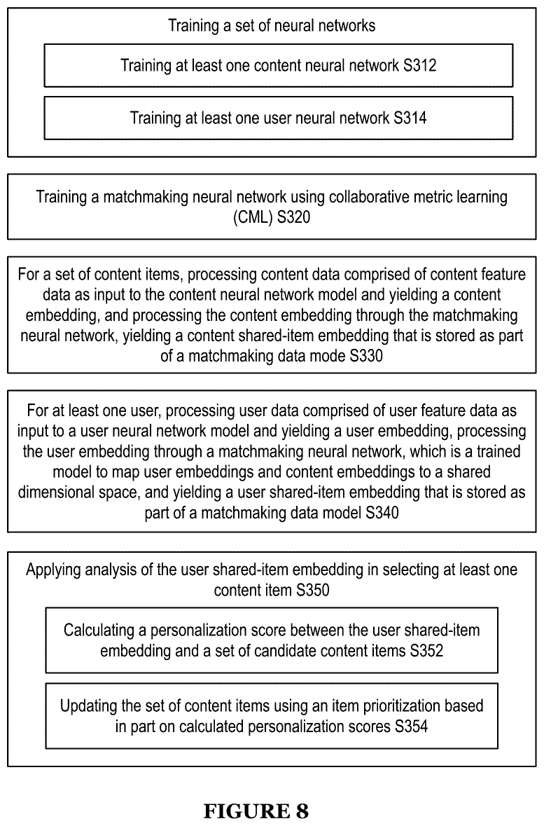

In some implementations, the method can include the training and management of the neural networks used in transforming data. As shown in FIG. 8, a method variation incorporating training of the neural networks can include: training at least one content neural network S312; training at least one user neural network S314; training the matchmaking neural network by applying collaborative metric learning S320; for a set of content items, processing content data comprised of content feature data as input to the content neural network model and yielding a content embedding, and processing the content embedding through the matchmaking neural network, yielding a content shared-item embedding that is stored as part of a matchmaking data model S330; for at least one user, processing user data comprised of user feature data as input to a user neural network model and yielding a user embedding, processing the user embedding through a matchmaking neural network, which is a trained model to map user embeddings and content embeddings to a shared dimensional space, and yielding a user shared-item embedding that is stored as part of a matchmaking data model S340; and applying analysis of the user shared-item embedding in selecting at least one content item associated with a content shared-item embedding within the matchmaking neural network S350, which comprises: calculating personalization scores between the user shared-item embedding and content shared-item embeddings of a set of candidate content items S352 and updating prioritization of the set of candidate content items based in part on a calculated personalization scores S354.

The method can be implemented by a computer system wherein one or more computer-readable mediums (e.g., (non-transitory computer-readable mediums) storing instructions that, when executed by one or more computer processors, cause the computing platform to perform the processes of the method (and/or their variations) described herein. The method can preferably be implemented by the system described above though any suitable system may be used.

In one variation, the method may be implemented as a specially configured computing system integrated as part of an internal computing solution, which can be used to enhanced search/recommendation performance of the computing solution. Accordingly, the method may be used as a single-tenant solution used within a single computing system (e.g., as the search engine hosted for a single site). For example, the method may be implemented within a media website, an e-commerce store, digital advertisement/promotional system, and/or other types of websites or services. Content, user, and/or interaction data may be accessed directly from internal computing resources.

In another variation, the method may be implemented as part of a specially configured computing system integrated within a software as a service (SaaS) multi-tenant computing platform.

Within such an implementation, multiple instances of the method may be operated for different scopes (e.g., accounts, websites, digital services). For example, distinct neural networks may be created and/or maintained for different platform accounts (e.g., websites or applications) making use of the SaaS computing platform.

Alternatively, within such an operation, the method may share resources or be used across multiple scopes of use (e.g., across different accounts). For example, some portion of the neural networks (e.g., the C-NN 120, U-NN 130, matchmaking neural network, and/or classifiers) may be trained, maintained, and/or used in search or recommendation operations for multiple accounts.

As yet another implementation variation, portions of the method be implemented through a hybrid computer architecture, wherein the method relays data input and output between distinct computing systems. This variation may have particular benefits where data security objectives dictate that some forms of data be maintained on-premise within a particular computing infrastructure.

In one variation, a SaaS implementation of the method is implemented in connection with an API, wherein an account is created and used by an external application or computer service to integrate with the search/recommendation capabilities of the SaaS platform. In some variations, an API may be used in supplying input data for user data, interaction data, content data. In some variations, an API may be used in requesting search results, predictions, recommendations, input autocompletion, and/or question and answer content search. Within recommendations, the API may enable requests of user-to-content recommendations, user-to-category recommendations, user-to-attribute/property recommendations, user-to-trending/featured content recommendations, product-to-product recommendations, and/or other types of recommendations. In some variations, the API may also be used in querying and analyzing data of user and/or content. For example, an API may be used to query the predicted audience for a piece of content.

While herein the method is described as it could be applied to content and user search/recommendation applications. The method may be adapted where content or users could be any suitable types of items. In one variation, the method may be used for one type of item. For example, variations of the method may be used for characterizing content with a C-NN and a matchmaking neural network such that content to content related enhanced search and recommendations can be used.

The process of generating and mapping items to the resulting matchmaking model may enable new capabilities to perform personalization and/or enhanced item-to-item predictions previously unachievable without access extremely large usage datasets (e.g., greater than 10 million, 100 million, or even a billion usage-related data records). As one potential result, content and/or users can be processed through a CML model of the method for what could be a form of N=1 personalization. In this way, the method enables new capabilities within a digital system to perform personalization and item comparison predictions with substantially less data and with higher prediction accuracy. For example, personalized search results and content recommendations can be achieved with as little as one input signal. In some implementations, the history of the last 10-50 interaction events of the current user (e.g., only keeping the last 20interaction events) may be used in personalization. Newly reported interactions can be used in reprocessing user feature data and updating a user associated user shared-item embedding.

As yet another benefit, the method's ability to adapt its predictions to small datasets, can make the predictions more responsive and adaptive to current interactions. As compared to a prediction engine that builds a single personalization prediction model from hundreds or thousands of interactions (possibly using persona-look-alike approaches) which may begin to provide highly static recommendations/predictions, the method can have personalization updates in response to the current and most recent interactions.

While variations of the method can make use of historical data records, the method can potentially have the benefit of rapidly generating personalized recommendations for a new user with a single datapoint of personal preference (e.g., an anonymous user clicking one product, viewing one piece of content, or supplying some personal preference information). For example, personalized media recommendations could be generated for a new user based on basic user profile information and without depending on observing the long viewing trends of the user and comparing those viewing trends to other users. While some implementations may make use of such metrics, the method may additionally be applied in situations where minimal history is available for an item (a content item or a user). Even in such instances, personalized user-content modeling can be conducted as an online or real-time model such that with each successful interaction between a user and content items, successive personalization can be improved, and better content recommendations can be generated.

The method may, in some variations, be used in generating personalized user-to-content related suggestions, which functions to perform affinity-based matchmaking of related content and/or users. For example, select pieces of content could be identified as matching a user's preferences. This content may be used in ordering content in a news feed, showing personalized product recommendations, ordering a search result page, personalization of user interfaces (e.g., customizing search results by personalized category/attribute filtering), and/or facilitating other digital interactions. In one exemplary approach, user-to-content comparisons may be used to filter or reorder a set of search results that were originally accessed using an initial search query process.

Similarly, for a given piece of content, the population of users with a level of interest in the content could be predicted from the CML model. The application of the CML model is not limited to identifying particular items but can also be used for other forms of content/user landscape analysis. For example, a content's shared-item embedding (i.e., the mapping of content items) within the CML model can be analyzed to identify user shared-item embeddings (i.e., the mapping of user items) in a certain region (e.g., within some distance from a point) and counting the number of user items mapped to that region to understand the population of predicted core audience.

The method may, in some variations, be used for user-to-user comparisons such as by identifying similar users, measuring or analyzing a population of users, and/or other comparisons of users using the CML model. For example, after a new user profile is processed and mapped within the model, similar users could be identified, within the CML model, in near proximity to the user item and surfaced to that user or to a digital platform for further application or analysis.

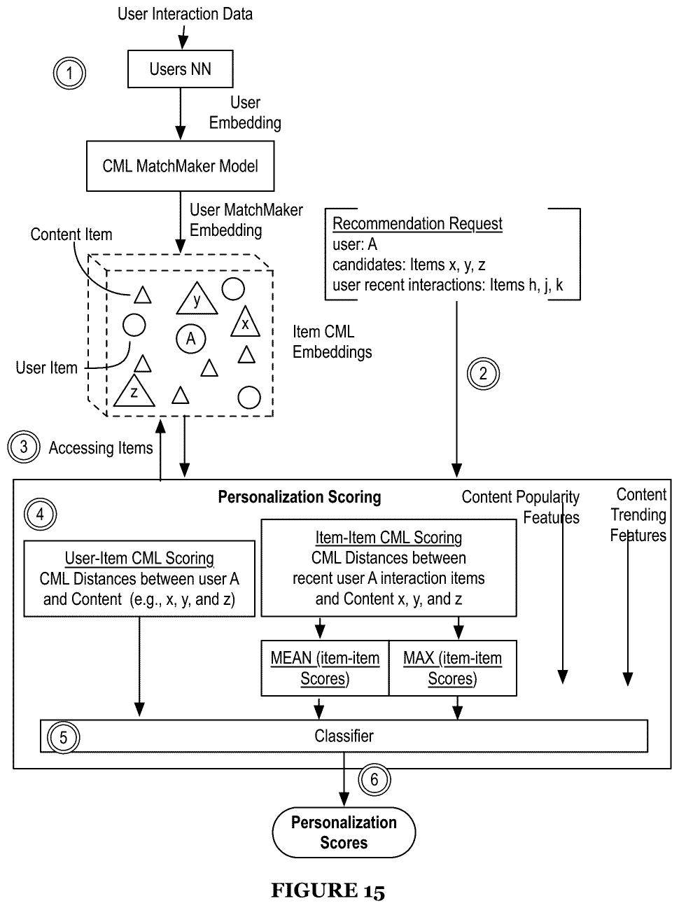

The method may, in some variations, be used for content-to-content comparisons such as identifying similar content items, dissimilar items, identifying analogous content relationships, and the like. For example, a particular piece of content could be processed and mapped within the model, and then similar pieces of content could be identified. In another exemplary use, content-to-content comparisons may be used in generating a personalization score of search results by using content-to-content comparisons to compare a set of candidate content items to other pieces of content with which a user recently interacted as shown in FIG. 15 where content-to-content comparisons are used in part to calculate a personalization score.

Block S110, which includes training a set of item neural networks functions to create one or more basis query model(s) that are used in processing items and mapping them to a vector space. Training a set of neural networks S110, when used for user and content comparisons, preferably includes training at least one content neural network (C-NN) S112 and training at least one user neural network (U-NN) S114. For each neural network from the set of neural networks, training a set of neural networks S110 preferably includes obtaining data for the neural network, training the neural network from obtained data, and incorporating a trained version of the neural network for content and/or user processing.

For a neural network from the set of neural networks, obtaining data for the neural network is preferably a component of training a set of neural networks S110. Obtaining data for the neural network may include crawling accessible data (e.g., world wide web and other available content ecosystems). Crawling accessible data may include copying relevant data to a desired repository and/or indexing the data. Obtaining data may alternatively include receiving data through API, loading data using an external content/user data service, directly accessing data through a direct integration with a content management system (CMS) of the website or application, or receiving or retrieving data in any suitable manner. Obtaining data may additionally include implementing natural language processing (NLP) to help identify, understand, and parse data. Similarly, computer vision (CV) processing of image or video media content may be used to analyze and characterize content of the media. Similarly, any other form of algorithmic. For audio-based content speech to text transcription, speaker identification/detection, content classification, musical classification, and/or any suitable form of audio analysis may be performed. Content of other media formats could similarly be analyzed and transformed into data characterizations. Obtaining data may include manually entering data, incorporating databases, libraries, and/or incorporating any accessible data repository. In some variations, obtaining data for the neural network may be data type specific. That is, the data is of a specific type, e.g., audio, video, text. In other variations, the type of data does not play a significant role. The type of data, and how it is obtained may or may not be unique to one neural network. That is, obtaining data for a neural network may or may not obtain the same data for two distinct neural networks, depending on the implementation.

In one variation, potentially used with a SaaS recommendation/search engine, content and/or user data may be received through an API. Accordingly, the method may include receiving content data through a content API. The content data can be converted to a set of content feature data suitable for input into a C-NN. Depending on the type of content, the content data may be varied. Properties of the content data submitted through an API can include content identifier, content title/name, content type, description, categories, tags, material, authors, colors, brand/manufacturer/company, size, and/or other custom attributes. The content properties collected for a particular piece of content can change depending on the content type and objectives for content suggestions.

Similarly, the method may include receiving user data through a user API. The user data can be converted to a set of user feature data suitable for input into a U-NN. The user data can include basic user profile information such as name, age, location, interests, and/or other descriptive information/data.

Additionally, in association with a user, the method may include receiving interaction data through an interaction API (or another suitable API interface). The interaction data may be used to record information and event records for interactions or events with an application or service. The interaction data may, in part, form part of the user data such that complete user data includes user profile related data and at least a subset of the interaction data of a user.

Examples of interaction events that may be received through the interaction API can include interaction details relating to one or more type of events such as a: product detail page view, category page view, a search (and the properties of the search query), impression (presentation of content to a user), add product to cart event, remove product to cart event, subscribe event, checkout event, refund event, read content, watch content, listen to content, add content to a collection (e.g., favorites, playlist, etc.), remove content from a collection, home page view, promotional content view, viewed content media, and/or other custom interaction events.

The obtained data can be used in training and/or populating one or both of the C-NN and/or U-NN. Preferably, the C-NN can be pre-trained and have content processed and mapped within the C-NN. The ingested data may be used, and the content item mapping maintained when the C-NN model is incorporated into live operation. Alternatively, the tuning of the C-NN performed during training may be used for a new distinct set of content used in live operation. In this variation, public content may be used in training the C-NN, but the resulting trained C-NN can be used for mapping of a set of private data. The training of a C-NN can additionally be used so that content (or users) can be processed by the relevant neural network at the time of their on-boarding, and therefore use of the neural network is not dependent on being used with a large database of content and/or users.

Block S112, which includes training at least one content neural network (C-NN) functions to build a model that preferably takes as input a set of content related features (i.e., content feature data) and generates a content embedding. Training of the model, as discussed above, may be performed through collected content data. Alternatively, the method may use a pre-specified C-NN. The resulting C-NN can preferably convert or transform raw content features (x) into a content representation f(x). In this description features x would be the content feature data and content f(x) would be the resulting output of a content embedding.

The implementation of the C-NN may depend on the type of content. As discussed, the method may be used with a variety of types of content such as text, images, audio, video, various categorical data (e.g., metadata for some type of content), and/or other types of content. In the case of text, the content may be processed as a set of word tokens. The C-NN for text can make use of neural network approaches such Deep Bidirectional transformers, Topic Modeling (not deep learning)+MLP. The C-NN for images, audio, and/or video may use convolutional neural network or other suitable types of neural networks. Categorical features could use multilayer perceptron (MLP) or other suitable types of neural networks.

Block S114, which includes training at least one user neural network (U-NN), functions to similarly build a model that takes as input a set of user-related data and generates an embedding. User data can include information and may depend on the application and available types of data during processing of the user data. User data could include data such as user profile information, job information, demographic data, location, search history, activity history, past purchases history, past product reviews, past media playbacks, data profile swipes, produced content (e.g., posts, “liked” items, etc.), and the like. The resulting U-NN can preferably convert or transform raw user data (y) into a user representation into a user embedding representation g(y). In this description features y would be the user feature data and content g(y) would be the resulting output of a user embedding.

Block S120, which includes training a matchmaking neural network using collaborative metric learning, functions to generate model that translates item embeddings to a shared-item embedding for processed user and content items. The resulting item matchmaking model (e.g., a CML model) is preferably used in transforming the content embedding and user embeddings from the C-NN and U-NN respectively. The output of the matchmaking neural network will be shared-item embeddings. The shared-item embeddings may be stored and persisted within a matchmaking data model (e.g., a CML data model). Data model here characterizes the resulting output and storage of the shared-item embedding. CML model more specifically characterizes a transfer function in the form of a neural network or other data transformation. Accordingly, the CML model is preferably applied to content embeddings from the C-NN and/or item embeddings of the U-NN. These shared-item embeddings are characterized as content shared-item embeddings for items corresponding to a piece of content and a user shared-item embedding for items corresponding to users.

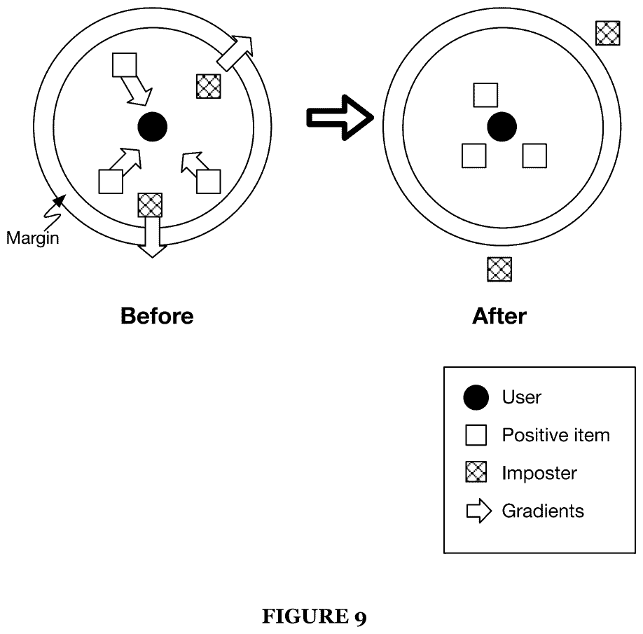

As shown in FIG. 9, a CML is preferably trained to transform user embeddings and content embeddings to a shared embedding space reflecting appropriate positioning in the shared vector space. In the shared vector space, the Euclidean distance:

$$d ( i , j ) = ‖ {u}_{i} - {v}_{j} ‖$$

preferably characterize a user i's relative preference for different items. In other words, items a user prefers will be closer to the user than items not preferred. In one variation, a gradient can be applied for a loss function to adjust item position to minimize loss function. The loss function can be:

$${L}_{m} ( d ) = {\sum }_{( i , j ) ϵ S} {\sum }_{( i , k ) ϵ S} {{w}_{ij} [ m + {d ( i , j )}^{2} - {d ( i , k )}^{2} ]}_{+}$$

where j is a content item liked by user i, and k is an item the user did not like. [z]₊=max(z,0) denotes the standard hinge loss, and wᵢⱼ is a ranking loss weight, and m>0 is the safety margin size. The gradients preferably apply to move items so that items with shown positive relationships (e.g., a user preferring a content item) are moved closer and items with negative relationships (e.g., a user disliking a content item) are moved further apart. The CML may additionally apply a rank-based weighting scheme such as a weighted approximate rank pairwise loss. In this variation, the items locations in the embeddings are preferably unconstrained in that they can move freely while meeting the user-item distances criteria.

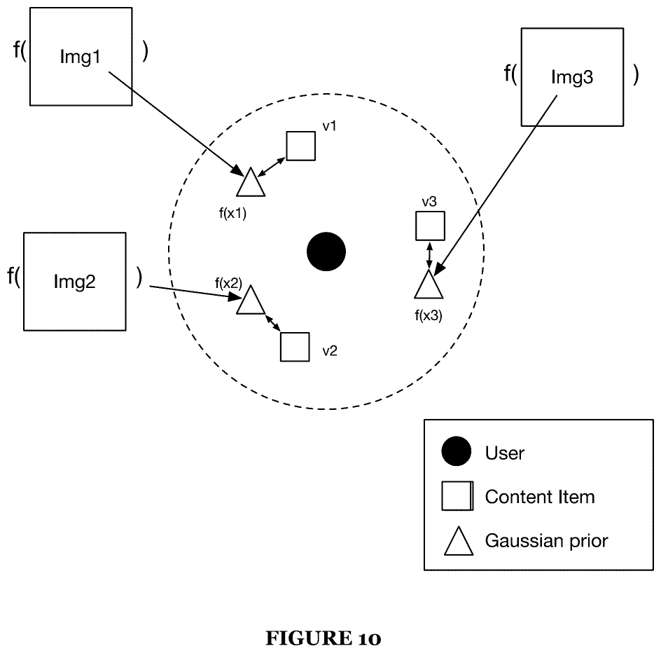

Additionally or alternatively, a content-aware version shown in FIG. 10 may be used where a function f can be trained to project content (e.g., image pixels, text characters, etc.) into the embedding. An additional constraint on the items' locations can be applied in a way they cannot be too far away from locations of their corresponding “projections”. This constraint may be applied by penalizing the distance between items and their projections. For example, if the vᵢ in the FIG. 10 is too far away from its projection f(x₁), this particular setting will get penalized. In this way, items that are similar in content (e.g., photos with similar color) will be brought closer. This, according to the rule shown in FIG. 9, can bring the user items closer to those content items that have similar properties to the content items the user previously liked.

Additionally, the CNN and UNN can be trained in connection with training of the CML model such that the CNN and/or UNN can be updated to minimize loss function as well. In one variation, the CNN, UNN, and the CML models may be combined into one computational model and trained simultaneously with a combined loss function.

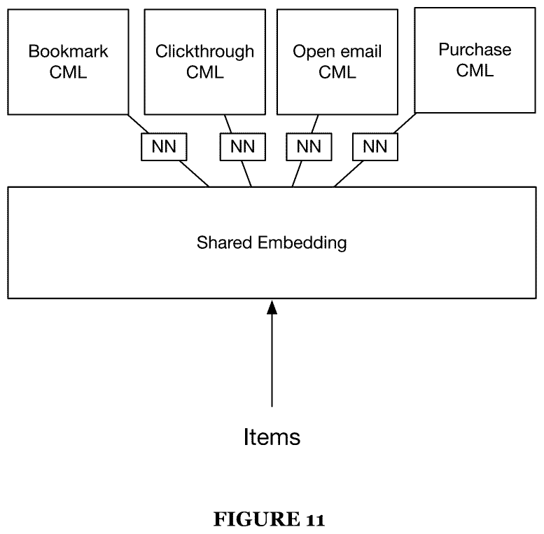

As one variation, multiple CMLS may be trained. In one implementation a first CML model is trained for a first application and a second CML model is trained for a second application. Examples of different types of CML models can include a CML for content positive ratings, CML for bookmark actions, CML for clickthrough modeling, CML for email opening, CML for purchases, and/or other suitable types of CMLs. As shown in FIG. 11, a combined computational model may implement a shared CML layer preceding an application-specific CML model.

As one variation, training the user neural network comprises and training the matchmaking neural network may be modified to amplify select interactions. Interaction amplification may be performed by biasing the training of the U-NN, C-NN, and/or a matchmaking neural network. One approach is to train using original user data as well as user data that only includes a select set of target interactions. For example, user data of a first user and an artificial copy of a select subset of user data of the first user may be used in training. If the select subset of user data is selected for one or more type of interactions, then this can bias the training of the neural networks towards that interaction.

Accordingly, training the user neural network comprises and training the matchmaking neural network may include: establishing a first set of user feature training data comprised of all user-associated interaction data and establishing a second set of user feature training data comprised of select set of user-associated interaction data; and training the user neural network on the first set of user feature training data and the second set of user feature training data, and training the matchmaking neural network by applying collaborative metric learning on using data derived from the first set of user feature training data and the second set of user feature training data.

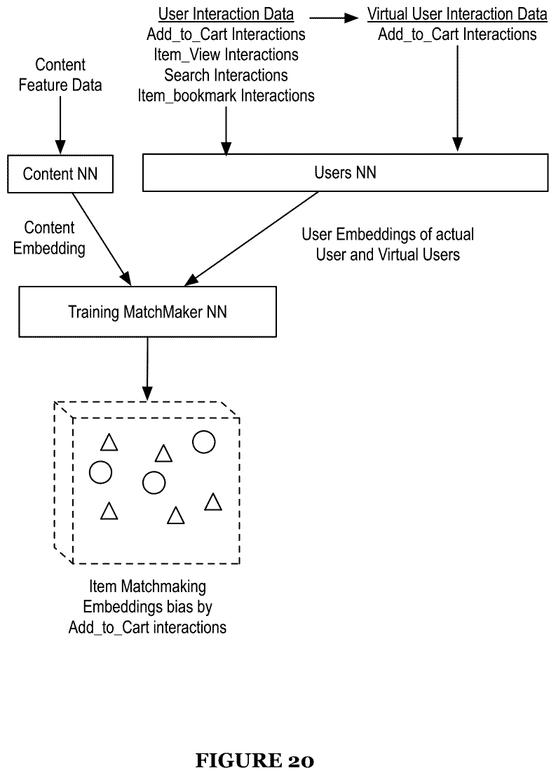

As one example, the neural networks may be trained on the full user interaction data as well as copies of the users with only purchase event interaction data as shown in FIG. 20.

Block S130, which includes processing an item through the neural network and at least the matchmaking neural network in generating a matchmaking data model, functions to map a content item or user item into the shared-item embedding space for analysis in block S140. Processing items through their respective neural network (e.g., the C-NN or U-NN) and then the matchmaking neural network preferably establishes a resulting data model of shared-item embeddings. Herein, this data model may be referred to as a matchmaking data model or more specifically a CML data model. The CML data model is a data model of all content shared-item embeddings and/or user shared-item embeddings. The CML data model is preferably queryable so that shared-item embeddings can be accessed for a given user or content item. The CML data model may be indexed by content and/or user identifiers. Different comparisons and assessments may be performed between two or more shared-item embeddings. In block S140, the CML data model may be accessed to perform distance calculations, counting of shared-item embeddings with particular vector-based relationships (e.g., within some distance, outside some distance), and/or performing vector-based operations (e.g., adding or subtracting shared-item embeddings).

The creation and/or resulting use of the CML data model can enable unique capabilities to a specially configured digital search and recommendation computing system. The representation of content and users in embedding form may be more data efficient, which may result in reduced data storage requirements. The CML data model also serves as a computational representation of content and users on which analysis can be more efficiently performed resulting in less compute cycles, which then translates to improved computational capabilities of such a specially configured computing system. In some events, the CML model can be stored in silica (e.g., within computer-readable medium) of a single specially configured computing device, and the stored embedding files are structured in the same way as they will be used in the main memory. These files are directly mapped into the computer's virtual memory space using the memory mapping technique such that queries can be readily performed without loading the whole embedding files into the main memory.

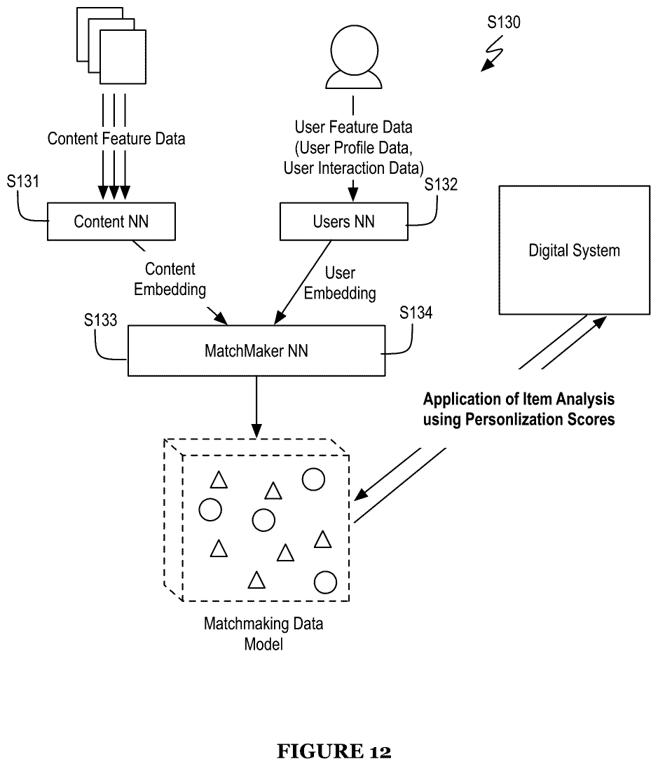

As part of configuring a matchmaking neural network, the method can include adding content to a data model (i.e., a matchmaking data model or more specifically a CML data model) of shared-item embeddings, which includes, for each content item, processing content data comprised of content feature data as input to a content neural network model and yielding a content embedding S131, and processing the content embedding through a matchmaking neural network and yielding a content shared-item embedding S133 as shown in FIG. 12. As discussed, the matchmaking neural network is preferably a trained model (e.g., a CML model) to map user embeddings and content embeddings to a shared dimensional space.

Adding content to the data model of shared-item embeddings is preferably performed for each content item. For example, an e-commerce may submit content data for each product for which search/recommendations are desired. In another example, a media content website may submit each article, video, or media item for which search/recommendations are desired. In another example, an advertisement delivery system may enter each advertisement or promotional content item for which user delivery recommendations are desired.

If the content is substantially static, content may be entered once. However, content shared-item embeddings may be periodically updated for changes in the content data, C-NN, and/or matchmaking neural network. Accordingly, updated training of the C-NN or the matchmaking neural network may result in reprocessing a content item by repeating the full or partial processing of content to translate the content data to content shared-item embedding. Content may be updated in its representation in the matchmaking neural network (as a content shared-item embedding) in response to new data such as: size/fit inventory changes of a product, price changes or discounts on products, social or public likes in social or content media, changes in content reviews, changes in content rating, and/or other changes in data related to a piece of content.

As part of configuring a matchmaking neural network, the method can include adding users to a data model (i.e., a matchmaking data model or more specifically a CML data model) of shared-item embeddings, which includes for each user item, processing a user data comprised of user feature data as input to a user neural network model and yielding a user embedding S132, and processing the user embedding through a matchmaking neural network and yielding a user shared-item embedding S134 as shown in FIG. 12. As above, the matchmaking neural network is preferably a trained model (e.g., a CML model) to map user embeddings and content embeddings to a shared dimensional space.

Adding a user to the data model of shared-item embeddings is preferably performed for any user for which personalization or consideration is desired. The user data may be processed ahead of time or on demand in response to a triggering event (such as the receipt of a query input associated with a user). In some implementations, user shared-item embeddings are calculated and stored as part of the matchmaking data model. However, user data may be processed on demand, especially in situations where the personalization depends on the relationship of one user shared-item embedding to other content shared-item embedding(s). On demand processing of user data to yield user shared-item embedding information can enable customization of recommendations to very recent user interactions.

The data relating to a user will generally be more dynamic than content data. Accordingly, user data may be reprocessed and updated within the CML data model in response to updated user data. For example, the method may include reprocessing user data in response to each new indication of user-associated interaction data. In one implementation, the user data includes any user profile data and a record of n-recent interactions (e.g., last 20 user interactions received through an interaction API), and a user shared-item embedding is updated for any changes in the user data. However, the reprocessing of a user shared-item embedding may be triggered in response to other conditions such as time conditions.

A user shared-item embedding may also be updated in response to changes in U-NN and/or matchmaking neural network. Accordingly, updated training of the U-NN or the matchmaking neural network may result in reprocessing a user item by repeating the full or partial processing of user data to translate the user data to user shared-item embedding.

Block S140, which includes applying analysis of a shared-item embedding in the matchmaking data model, functions to use the shared vector space modeling of an item within the matchmaking data model in altering a digital interaction or operation. More specifically, applying analysis of shared-item embeddings in the matchmaking neural network involves applying analysis of data model relationships between two or more shared-item embeddings in a CML data model.

Block S140 may be used in applying analysis of the user shared-item embedding in selecting at least one content item. In this variation, one or more digital records may be accessed or selected based at least in part on the analysis of one or more shared-item embedding.

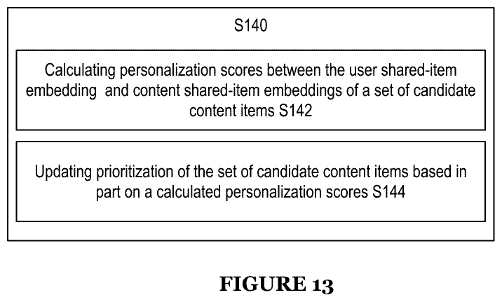

Applying analysis of the user matchmaking embedding in selecting at least one content item comprises: calculating personalization scores between the user shared-item embedding and content shared-item embeddings of a set of candidate content items S142; and updating prioritization of the set of candidate content items based in part on a calculated personalization scores S144 as shown in FIG. 13.

Other alternative forms of analysis of a shared-item embedding may alternatively be used. In alternative variations, analysis of shared-item embedding may include identifying one or more shared-item embeddings satisfying a condition. The condition may be a proximity condition wherein proximity is defined as a displacement condition in the multi-dimensional vector space of the shared-item embeddings. In one example, the x number of users or content items may be selected by identifying the x number user or content shared-item embeddings nearest another shared-item embedding. In another example, the count of user or content shared-item embeddings within (or outside) a specified distance threshold from a reference shared-item embedding may be used to determine content or users with some degree of similarity (or lacking some similarity).

Such shared-item embedding calculations and/or comparisons can be integrated into various search and filtering operations for various applications. By way of example, applying analysis of a shared-item embedding in the matchmaking data model S140 may be used for delivering search results, generating content recommendations, generating item pairing recommendations, powering form autocompletion, and generating a report as a partial list of applications. How candidate items are initially selected and how an affinity/personalization score is used will depend on the particular application. Exemplary variations of such processes are described herein.

Block S142, which includes calculating personalization scores between the user shared-item embedding and content shared-item embeddings of a set of candidate content items, functions to assess the affinity between a user and a set of relevant content items. Calculating a personalization score (more generally referred to as an affinity score) may be performed through a variety of approaches.

In one variation, calculating the personalization score will include calculating the displacement distance between at least two shared-item embeddings. Calculating the distance can be a Euclidean displacement between at least two shared-item embeddings. Performing vector math on two or more shared-item embeddings can be done as a user-to-content comparison, user-to-user comparison, or a content-to-content comparison.

Alternative approximations of distance may be used in assessing a “proximity” metric within the matchmaking data model. In some variations, the consideration of proximity of more than two items may be calculated. For example, the personalization approaches described herein for personalizing to a single user may be similarly modified for personalization to a plurality of users by considering the proximity of the plurality of users to different items. This may involve averaging distance calculations, taking maximum and/or minimum distance calculations, or generating other proximity metrics.

In some variations, a displacement metric may be used directly in generating a personalization score. In another variation, multiple displacement calculations may be used for related items and processed when generating a personalization score. In other variations, a displacement metric may be used as one input into a classifier to generate a personalization score.

In some variations of calculating a personalization score, additional factors such as content age, content popularity, content trending properties (e.g., recent change in popularity), content attributes (e.g., featured, cost/margin, etc.), custom properties, and/or other aspects may be factored into a personalization score. This may be used to integrate other contextual factors into the generation of results. These supplemental factors can be incorporated into the reranking process, used to filter or set candidate items, or otherwise used in altering the generation of results for a given query input. In one implementation, contextual data or supplemental factors can be used as inputs to a classifier to generate a personalization score.

Furthermore, depending on the selected application, the selection and/or training of a neural network may be used to bias such personalization towards different objectives. For example, a neural network that was biased towards particular interactions (as discussed herein), such as purchase related events for a product, may be used so that product search results are biased towards the products a customer is more likely to buy as opposed to simply clicking and viewing the product as a general impression.

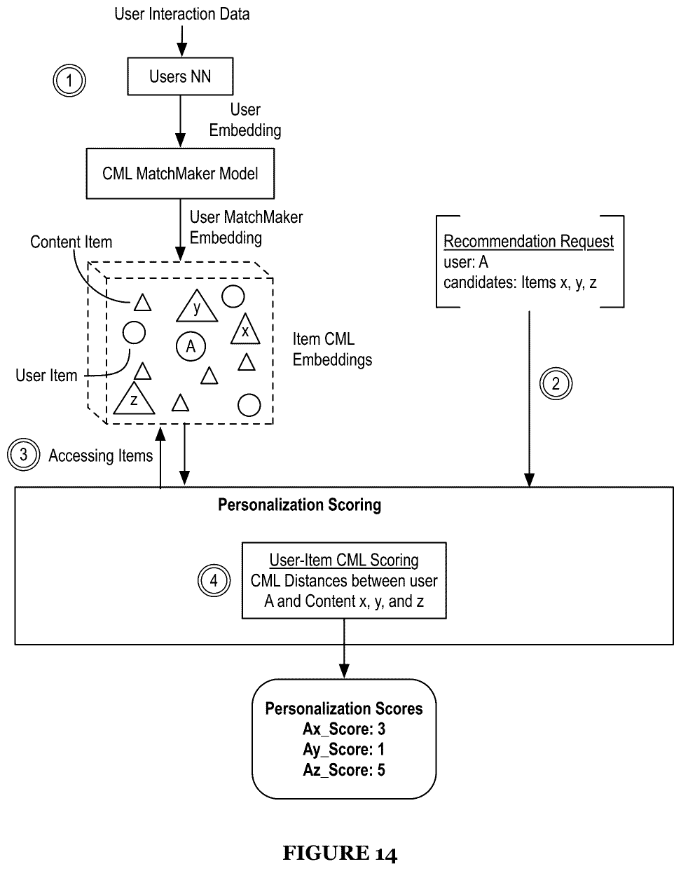

In a first distance-based variation of the personalization score, calculating the personalization score may be based directly on the distance between two shared-item embeddings. When used for calculating the personalization score of a content item and a user, calculating the personalization score includes calculating the distance between the content shared-item embedding and the user shared-item embedding as shown in FIG. 14. The distance can be calculated as a Euclidean distance calculated for the defined vector of each shared-item embedding.

In a second variation, the personalization score may be based on multiple inputs to a classifier wherein at least one classifier input is based on an analysis of a shared-item embedding of the matchmaking data model. This variation may enable multiple aspects of item relationships to be factored into the personalization score. It may also allow biasing of the personalization score with context information such as content popularity.

As an exemplary implementation of such a variation where the personalization score is based on classification of multiple inputs, calculating the personalization score can include calculating a user-to-content comparison as well as content-to-content comparisons between the candidate content items and user associated content items (e.g., the content items most recently visited, purchased, favorited, or otherwise interacted with by the user). The results of these two comparisons are supplied as inputs to a personalization score classifier. Additional inputs such as popularity, trending, and/or other attributes may additionally be used as inputs into the score classifier.

As shown in FIG. 15, in one example, calculating a personalization score for one content item by classifying multiple inputs (with at least one input partially based on shared-item embeddings in the matchmaking data model) can include:
a) Calculating a user-item displacement between a user shared-item embedding and a content shared-item embedding of a set of candidate items (generating user-item score).
b) Calculating content similarity classifier input by: querying a content database to access a user-associated set of content items; for each user-associated content item of the user-associated set of content items, calculating content-to-content displacement between each “user-associated” content shared-item embedding and the content shared-item embedding of the set of candidate items (generating content-content scores). Querying the content database to access user associated set of content items may be used in determining most recent user-interacted-with content items, determining recent or top content items associated with some select interaction (e.g., purchasing, watching, favoriting, sharing, clicking, etc.), or establishing other user-associated relationships to content.
c) Processing measurement of the content-content displacements which can include calculating the mean of the set of content-content displacements and calculating the maximum content-content displacement of the set of content-content displacements. Processing measurement of the content-content displacements functions to assess how the content item relates to various user-related content.
d) Optionally collecting supplemental context data such as popularity rankings, trending scores, custom metrics like profit margin, and/or other contextual data.
e) As input to a classifier, processing the user-item displacement, the maximum content-content displacement, the mean content-content displacement, and optionally one or more contextual data inputs, and thereby outputting a personalization score. Depending on the implementation, a classifier may take different numbers, combinations, and types of inputs.

The letter labels as used herein (e.g., a, b, c, d, and e) are presented here for explanation only and do not imply any required order or sequence of operations. Alternative permutations and alterations to the input of the classifier may similarly be used.

Described in terms of classifier inputs, a process without contextual factors may be described as: generating a first classifier input by calculating a displacement between the user shared-item embedding and the content shared-item embedding; generating at least a second classifier input by calculating a set of user-related content displacements between the content shared-item embedding and a set of user-related content shared-item embeddings; and processing the first classifier input and at least the second classifier input within a classifier model and outputting the personalization score.

Described in terms of classifier inputs, a process with contextual factors may be described as: generating a first classifier input by calculating a displacement between the user shared-item embedding and the content shared-item embedding; calculating a set of user-related content displacements between the content shared-item embedding and a set of user-related content shared-item embeddings; generating a second classifier input by calculating an average of the set of user-related content displacements; generating a third classifier input by calculating a maximum of the set of user-related content displacements; generating at least a fourth classifier input by receiving contextual data inputs (e.g., popularity metrics, trending metrics, other contextual metrics); and processing the classifier inputs within a classifier model and outputting the personalization score.

As yet another example of personalization score with a popularity factor, a process may include: generating a first classifier input by calculating a displacement between the user shared-item embedding and the content shared-item embedding; generating at a second classifier input by receiving contextual data inputs (e.g., popularity metrics, trending metrics, other contextual metrics); and processing the classifier inputs within a classifier model and outputting the personalization score. As is exemplified, the personalization score may be customized to incorporate different aspects depending on objectives.

In some variations, the method may adapt the use of different inputs and their classifier for different applications. In this way, the method may make use of personalization scores with different context scopes such as a personalization score with popularity, a personalization score with popularity and trending ranking, a personalization score with profit margin consideration. In one variation, the query input may specify a parameter indicating the context features to be used in generating personalized query results.

Block S144, which includes updating prioritization of the set of candidate content items based in part on calculated personalization scores, functions to alter scoring and/or ordering of a set of candidate items being evaluated. The resulting altered scoring/order can then be used in delivering a personalized order list of items or selecting a subset of items for some digital interaction. The set of candidate items (e.g., users or content items depending on the application) are preferably reprioritized in a manner that factors in an item's personalization score-an assessed affinity between items. The initial set of items may be generated from a preliminary data process such as an initial search relevancy process identifying a filtered set of candidate items. The set of candidate items may be unscored or ordered candidate items in which case updating prioritization can be the assignment of scores and order. The set of candidate items may alternatively be accompanied by a score or an order such as when the candidate items are the results of a relevancy search.

In some cases, the set of candidate items may be supplied, however in other cases, the set of candidate items may be generated by the method.

In one variation, the application of the matchmaking data model to a particular application will generally include receiving a query input, initially selecting a set of candidate items for the query input and updating prioritization of the set of candidate items using comparisons of two or more shared-item embeddings.

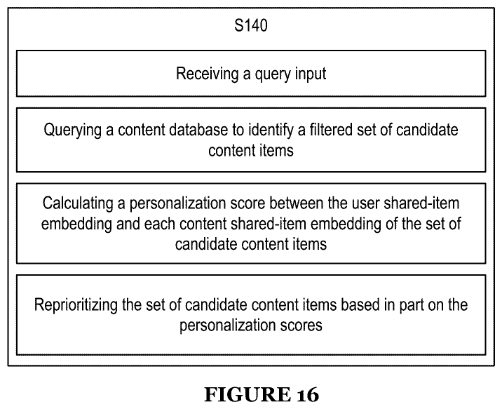

As shown in FIG. 16, when used in delivering user personalized results for different content-related queries, this process will include receiving a query input, querying a content database to identify a filtered set of candidate content items, calculating a personalization score between the user shared-item embedding and each content shared-item embedding of the set of candidate content items, and reprioritizing the set of candidate content items based in part on the personalization scores.

In some alternative applications, the use of the matchmaking data model is used in the initial generation of candidate items. Instead of querying a content database, some variations can include identifying the set of candidate content items through inspection of the matchmaking data model. This may include identifying a set of shared-item embeddings satisfying a proximity condition relative to an anchor item. Secondary reprioritization processes may additionally be used in reranking such an initial set of candidate items.

The query input will generally include properties defining the nature of a request such as the user and/or content items for which an analysis is performed. The query input may in some applications be associated with user interactions such as the submission of a search query. However, the query input can more generally be any programmatic request for results. For example, a query input can be received through an API request specifying a request for personalized product recommendations for pairing with one or a set of products in a customer's cart, as a means of “completing” a user's shopping effort before they checkout.

Updating of prioritization of the set of candidate items using comparisons of two or more shared-item embeddings preferably uses user-to-item, item-to-item, and/or user-to-user comparisons. These comparisons will involve the calculation of a personalization score. The updating of prioritization may be a reranking of an ordered set of candidate items. The updating of prioritization may alternatively be assigning of ranking by scoring the set of candidate items. The prioritization will generally involve the calculating of a personalization score which may depend on one or more aspects.

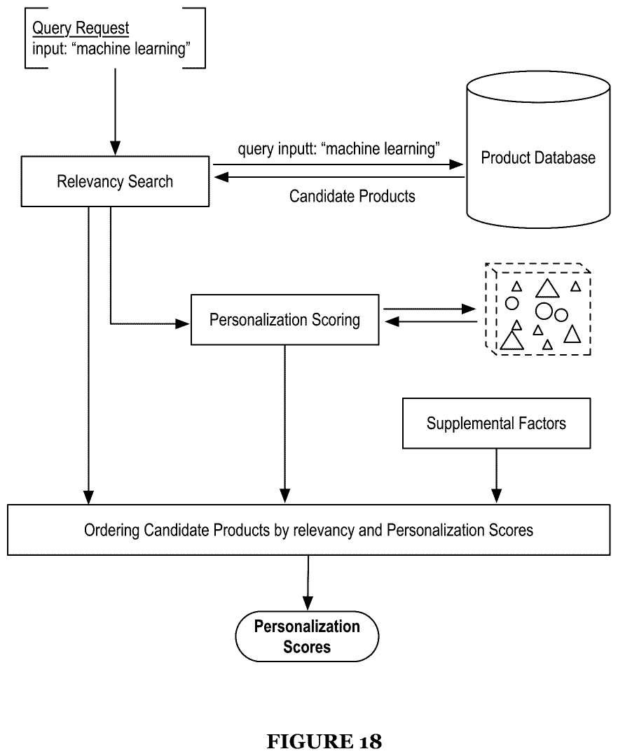

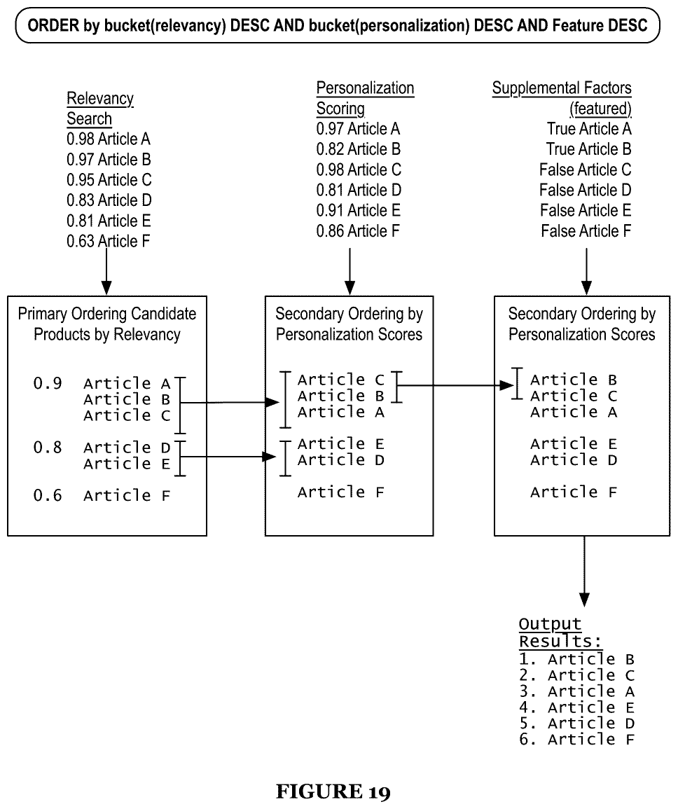

The personalization score can be used in prioritizing or biasing generation of query results. In some variations, the use of tiered grouped prioritization is used in consolidating similarly scored/ranked items such that supplemental score prioritization can be performed. Accordingly, updating prioritization of the set of candidate items can include grouping the set of candidate items into a set of candidate item groups and reprioritizing candidate items within a candidate item group based on the matchmaking data model, which functions to bucket similar candidate items and then reprioritize within a group based on personalization scores. This can enable the combination of multiple scoring approaches as shown in FIG. 18. Such a grouping process consolidates items based on different metrics (e.g., relevancy score, personalization score, etc.) as shown in FIG. 19.

This grouping and reprioritization can use any suitable scoring metric as a “tie-breaker” for content items of similar results. In many applications, a personalization score is used as a tie-breaker after consolidation of an initial scoring of content items. When used on a set of candidate items ordered by relevancy score it can add a flavor or personal affinity to the ordering of relevant results. The content results are still appropriate, but those that are substantially similar in relevancy can be reshuffled based on user affinity.

As an example, where such tiered grouping is used within personalized search, the updating of prioritization can include grouping a set of candidate content items (scored by search relevancy) into a set of relevancy-groups; and reprioritizing the set of candidate content items by using personalization score to order candidate content items within the shared relevancy groups.

As shown in FIG. 19, when tiered grouping is integrated into delivery of user personalized results for different content-related queries, the process of applying analysis of a shared-item embedding in the matchmaking data model may include: receiving a query input, querying a content database to identify a filtered set of candidate content items, grouping the set of candidate content items into a set of relevancy-groups, calculating a personalization score between the user shared-item embedding and each content shared-item embedding of the set of candidate content items, and reprioritizing the set of candidate content items based in part on the personalization scores by reprioritizing the set of candidate content items by using personalization score to order candidate content items within the same relevancy group.

Grouping may, in some variations, be performed by using a group classification process or by using a heuristic approach. In some variations, grouping may be performed by implementing k-means clustering or percentile discretization. As an exemplary implementation of one approach that can be used for grouping, relevancy scores of two candidate items may be compared and grouped if the difference is within a set percentile limit. When grouped, the relevancy score of the relevancy group may be assigned based on the relevancy scores of items within the group. For example, the relevancy scores of search results 1 and 2 may be compared and if the difference is less than 10% then a relevancy group is formed including items 1 and 2 and a relevancy score for that relevancy group is assigned as the average of 1 and 2. The relevancy group is then to replace items 1 and 2 for score comparisons so, for example, the relevancy score of the relevancy group may then be compared to item 3 to see if item 3 should be grouped in or not.

These variations of applying analysis of shared-item embeddings may be adapted for generating results for a variety of different query requests. As discussed, block S140 may be used for delivering search results, generating content recommendations, generating item pairing recommendations, powering form autocompletion, and/or generating internally a report on user-content affinities and trends (e.g., for product leadership, website/app operators, etc.) as a limited list of exemplary applications. Exemplary details of such approaches are presented below.

In a personalized search variation, block S140 may include applying analysis of the user shared-item embedding in selecting at least one content item within a set of query results in response to a search query, which functions to return query results selected and/or ordered using the matchmaking data model. The use of the matchmaking data model is preferably used in combination with another search process such as a TFIDF (term frequency-inverse document frequency) search.

In one variation, search results may be significantly improved by personalizing search results by analyzing shared-item embeddings in the matchmaking data model. The method can be used for deep personalization utilizing a history of previously observed user activity. The method may alternatively be used to extend personalization beyond traditional search capabilities to offer substantially real-time personalization based on current or recent activity. For example, personalization may be based on a fixed time window such as activity in the last 10 minutes, hour, day, or week. As another example, personalization may be based on a fixed set of interactions such as the last 20, 50, or 100 interactions. Any suitable time window and/or interaction history limits may alternatively be used.

Furthermore, variations of the method may enable the method to be biased towards returning search results that are predicted to yield particular actions (e.g., product views, add to cart events, sharing, etc.). As discussed above, a matchmaking neural network trained with biased training data (e.g., training data selected to emphasize particular actions) may be used to generate personalization scores with a tendency towards selected activities.

This variation may be implemented in combination with a search engine that enables a user to enter a user query with the objective of generating a list of query results. Accordingly, the method may include receiving a search query input. The search engine preferably includes an interface to receive the user query. The search engine may additionally include a primary content search system. The primary content search system may use a variety of techniques and search tools. The primary content search system may use attributes and features such as term frequency-inverse document frequency techniques, item popularity ranking, recency of items, historical clickthrough/interaction history of the same or similar query). The primary content search system can supply an initial result that may be then re-ranked by the CML.

Executing the query within a primary content search system, outputs an initial set of candidate content items. The set of candidate content items may have a relevancy score based on the search algorithm or other metrics. The scoring, ordering, and general prioritization can then be updated using personalization scores.

Exemplary implementations may include variations of the below stages:
a) Receiving a first query input. The query input specifying a search term and/or any search parameters (e.g., filters or conditions). The query input can additionally indicate at least one associated user identifier. Alternatively, the associated user may be determined based on information from the current context (e.g., the currently logged in user).
b) Querying a content database to identify a filtered set of candidate content items. The querying of the content database can be performed using a textual relevancy search process. The set of candidate content items may be limited to a set number of results such as 200, 1000, or other suitable number of results. The number of results used may depend on the variance in the relevancy score. More candidate content items may be selected if the relevance scores are substantially equivalent (less than 10-20% different).
c) Calculating a personalization score between the user shared-item embedding and each content shared-item embedding of the set of candidate content items. In one variation, the personalization score may include calculating the Euclidean distance between the user shared-item embedding and a content shared-item embedding. In another variation, the personalization score may include consideration of multiple inputs that is then classified such as those shown in FIG. 15 wherein the personalization score may be described as classification of: i) content-to-user distance, ii) mean of the set of shared-item displacements between a candidate content item and a set of user-associated content items, iii) max of the set of shared-item displacements between a candidate content item and a set of user-associated content items, iv) optionally, a popularity metric and/or trending metric, and/or v) other optional classifier inputs such as profit margin, content classification, and/or other contextual data features. The user-associated content items in one example could be the last n-number of content items that received a user interaction (e.g., last 5 viewed items, last 5 products purchased, etc.).
d) Updating prioritization of the set of candidate content items based in part on the personalization scores.

In one variation updating prioritization of the set of candidate content items based in part on the personalization scores uses grouping of candidate items between application of different prioritization factors.

As an example of the grouping process used for updating search result prioritization, updating prioritization can include grouping the set of candidate content items into a set of relevancy-groups; and within each relevancy group setting the priority order based on personalization scores of the content items within the relevancy group. Further grouping and updating of prioritization may further be performed for additional factors.

Accordingly, descriptions of various exemplary reprioritization processes may include the following examples where bucket(X) is used as a descriptor of the reassignment of X scoring by grouping similar X scores:
a) “ORDER by bucket(relevancy) DESC AND bucket(personalization)” This would perform a primary ordering by relevancy and then a secondary ordering by personalization score.
b) “ORDER by bucket(relevancy) DESC AND bucket(personalization) AND feature” This would perform a primary ordering by relevancy, then a secondary ordering by personalization score, then final ordering by feature attribute as shown in FIG. 19.
c) “ORDER by bucket(relevancy) DESC AND bucket(personalization_with_popularity) DESC AND bucket(personalization_without_popularity) DESC” This would perform a primary ordering by relevancy, a subsequent ordering by a personalization score that includes popularity as a classifier input, and a final subsequent ordering by a personalization score without considering popularity.
c) “ORDER by bucket(relevancy) DESC AND bucket(personalization_with_popularity) DESC AND bucket(personalization_without_popularity) DESC AND Margin DESC” This would perform a primary ordering by relevancy, a subsequent ordering by a personalization score that includes popularity as a classifier input, a subsequent ordering by a personalization score without considering popularity, and then finally ordering by some other metric such as a profit margin metric if the content is a product.

In a content recommendation variation, block S140 and the method in general can be used in generating a content recommendation by relating a user shared-item embedding of a user to content shared-item embeddings in the matchmaking data model. Block S140 may include applying analysis of the user shared-item embedding in selecting at least one content item with similarity to one or more shared-item embedding as indicated by a recommendation query.

In one variation, applying analysis of shared-item embeddings in the matchmaking data model can include, for a given user, identifying one or more content items based on proximity within the matchmaking data model, which corresponds to identifying content preferred by the user. Identifying an item based on proximity can include identifying an associated content item with a corresponding shared-item embedding within a defined threshold Euclidean distance to at least another shared-item embeddings (e.g., a user shared-item embedding or a user-associated content shared-item embedding for example), which can function to identify content with some approximate measure of affinity to a user or another piece of content. Conversely, items outside a defined threshold Euclidean distance may be used to identify items with some measure of user dislike or lack of affinity.

This content recommendation variation can be used for delivering recommendations of content items similar to another content item, content recommendations based on recent trends, personalized content recommendations for content within a particular category or matching other content attributes.

In a variation for recommending content for a given user, a set of candidate content items may be generated by finding content items that have some affinity relationship to a user. In one implementation, instead of querying a content database, the process of generating candidate content items can include identifying a set of content items with greatest similarity to a set of user-associated content items. This may be implemented by, for example, finding 3000 content items that are similar to the last 5 content items that the user interacted with. Here, greatest similarity may be measured based on those with the minimal distance metrics to the user-associated content items. This distance metric may be based on the average displacement between the user associated content items and content items, the total sum displacement between the user associated content items and content items, and/or other ways of assessing proximity within the vector space of the matchmaking data model.

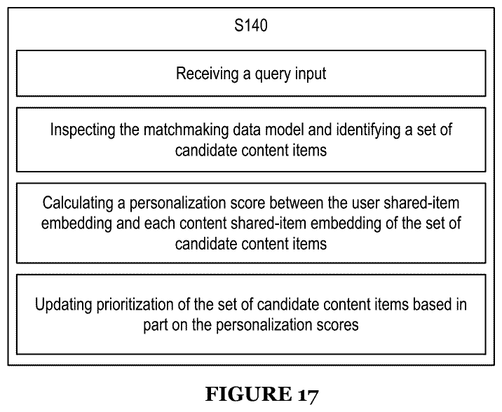

Exemplary implementations of content recommendations may include variations of the below stages, as shown in FIG. 17:
a) Receiving a first query input. The query input specifying the parameters of a content recommendation request such as the number of requested recommendations, filters, or properties like category limits. The user will either be explicitly indicated in the query input or ascertained in other ways.
b) Inspecting the matchmaking data model and identifying a set of candidate content items. As discussed above, this process uses the vector positioning of shared-item embeddings in the matchmaking data model to determine a pool of content items that appear similar to one or more anchor items. When recommended only with the context of a user, the candidate content items may be those in proximity to the user shared-item embedding and/or those in proximity user-associated content shared-item embeddings.
c) Calculating a personalization score between the user shared-item embedding and each content shared-item embedding of the set of candidate content items. The various personalization scoring approaches may be used.
d) Updating prioritization of the set of candidate content items based in part on the personalization scores. In one variation, the candidate content items may be directly ranked based on their personalization score, in which case there may be no updating of a previous ranking but just the direct assignment of score or ranking. Tiered grouped prioritization as described above can similarly be used. One exemplary reprioritization process may be characterized as “ORDER by bucket(personalization_with_popularity) DESC AND contextual_metric”. Additional subsequent prioritization factors may also be used. For example, if the content is a product, then product margin, sales priority, inventory, may be used to augment ranking of products.

In a variation for recommending trending content, the recommendations function to personalize the selection and/or ordering of trending content. This personalized ranking of trending content may be presented as a list of personally recommended trending content. However, one or two content items may alternatively be selected and used within a user interface. For example, this process may be used to determine which trending news stories to surface to a user within a news feed.

This variation preferably selects a set of candidate content items based on the trending properties. Accordingly, querying a content database to identify a filtered set of candidate content items as described above can be modified for selecting a set of candidate content items based on trending properties over some specified length of time (e.g., last 24 hours, 7 days, month, year, etc.). This set of trending candidate content items can then be reprioritized using the approaches described above. One exemplary reprioritization process may be characterized as “ORDER by bucket(trending_score) DESC AND bucket(personalization_with_popularity)”. Additional subsequent prioritization factors may also be used.

In a variation for recommending categories or topics, the process of generating content recommendations described above may be performed. Then within the set of resulting recommendations, the method can include analyzing categories of the recommended content items to generate a list of recommended categories. These category recommendations will generally be the categories most common across the set of resulting recommendations. In one variation, weighting of categories may be used based on the personalization score or the contents ranking within the set of recommended content items. This process may be used to suggest topics or categories that may be of interest to a user.

In a related variation, other recommendations around content attributes may be made. As with the category recommendations, attributes of content in the set of recommended content items can be analyzed and used in generating recommended attributes. In one example, recommended products may be used to determine recommended product colors by determining common color patterns within the recommended products.

In a variation for recommending content related to other content, relationships of content shared-item embeddings may be used to interpret how content relates to one another. This variation may use an alternative approach to applying analysis of the shared-item embeddings in the matchmaking data model wherein an initial set of candidate content items are selected based on inspection of item shared-item embeddings that correspond to one or more anchor items. This variation may also differ from other approaches in that user shared-item embeddings may not be used. In some alternative variations, the use of a user neural network and modeling of user shared-item embeddings may not even be used when the method is only used for content item analysis. In such a variation, the personalization scores may alternatively be described as affinity scores but can use similar scoring processes that substitute an anchor content item for a user item. However, user personalization can be incorporated in some variations.

Exemplary implementations of content-to-content recommendations may include variations of the below stages:
a) Receiving a first query input. The query input specifying at least one anchor item and any other recommendation parameters. If the content-to-content recommendations are personalized, a user identifier may be supplied directly in the query or indirectly through other context data.
b) Inspecting the matchmaking data model and identifying a set of candidate content items. This process can use the vector positioning of content shared-item embeddings in the matchmaking data model to determine a pool of content items that appear similar to one or more anchor items. For example, the 100 content items in nearest proximity to the anchor item may be selected.
c) Optionally calculating a personalization score between a user shared-item embedding and each content shared-item embedding of the set of candidate content items. The various personalization scoring approaches may be used.
d) Updating prioritization of the set of candidate content items based in part on the personalization scores. In one variation, the candidate content items may be directly ranked based on their personalization score, in which case there may be no updating of a previous ranking but just the direct assignment of score or ranking. Tiered grouped prioritization as described above can similarly be used.

One exemplary reprioritization process may be characterized as “ORDER by bucket(trending) DESC AND bucket(personalization_with_popularity) DESC AND contextual_metric”. Additional subsequent prioritization factors may also be used. For example, if the content is a product, then product margin, sales priority, inventory, may be used to augment ranking of products.

This process may similarly be adapted to other content recommendation use cases. For example, this process may be adapted to supply recommendations on products that are commonly purchased together, or media content viewed/accessed afterwards. Among the products that tend to be purchased together, this process further prioritizes the ones that have higher personalization scores and rank them higher in the recommendations.

As a different application of the matchmaking neural network, block S140 may be applied to powering search query autocompletion. A similar process may be used: generating candidate content items and then prioritizing using affinity analysis from the matchmaking data model.

In a title completion autocomplete application, a set of candidate content items may be identified using a prefix or search term matching algorithm so that content with matching or near matches of a query input (e.g., having an edit distance under some threshold) can be identified. The content items are preferably identified by querying a content database. With such a set of candidate content items generated, personalization scores may be used in personalizing the candidate content items. In one exemplary variation, updating prioritization may be characterized as “ORDER by Bucket(Edit_Distance) ASC AND bucket(personalization_with_popularity)” If any search filters are applied in the query input then the candidate content items may be modified based on those filters.

Finally, as this is part of an autocomplete user interface element, the resulting content items are served to a user interface form where the user interface is updated and changed to display the personalized list of autocomplete content items.

In another variation, block S140 can be used in generating a report for content and/or items, which functions to generate data analysis. The reports may include information for a single content and/or user item or alternatively a plurality of content and/or user items. In one example, CML data model may be inspected and queried. Content producers or others interested in the relationships of content can use this to better understand relationships of content and users. For example, generating a report may include identifying similar content items (e.g., for highlighting comparable content), counting similar content items (e.g., for reporting on crowding in the content space), counting user items (e.g., reporting on population of target audience), and/or making other suitable forms of analysis.

In some variations, returning query results based on the matchmaking data model are used in implementing a content delivery system. The content delivery may function to select appropriate content based on the CML model and communicate the content to an appropriate system. When delivering a single piece of content, the content item may be selected from a prioritized set of content items such as one resulting from one of the query processes described above.

In general, the content delivery system will communicate the content to a user interface. The content delivery system may be used in personalizing content presentation, serving relevant advertisements or notifications, personalized feed content, playlists, card-swipe interaction models, and/or for other suitable applications. In one variation of content delivery, block S140 is applied to serving an advertisement or promotional piece of content. The content may be generated or selected based on Euclidean proximity of the user-content embedding proximity in the CML model. In this way more personally relevant advertisements or content can be delivered to a user.

### 4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor of a specially configured computing system.

In one variation, a system comprising of one or more computer-readable mediums (e.g., non-transitory) storing instructions that, when executed by the one or more computer processors, cause a computing platform to perform operations comprising those of the system or method described herein such as: training a content neural network, training a user neural network, training a matchmaking neural network using collaborative metric learning, processing an item through the neural network and at least the matchmaking neural network in generating a matchmaking data model, and/or applying analysis of a shared-item embedding in the matchmaking data model.

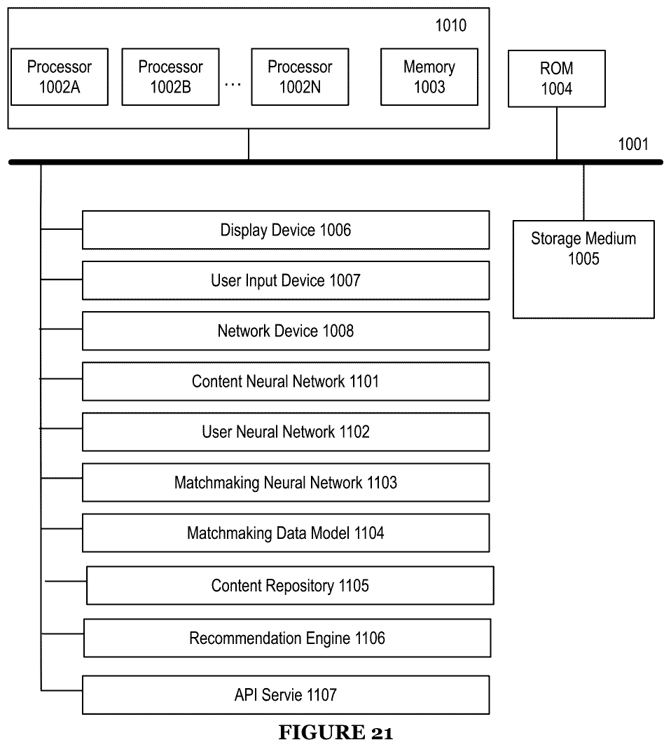

FIG. 21 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random access memory (RAM)) 1003, a read only memory (ROM) 1004, a processor-readable storage medium 1005, a display device 1006, a user input device 1007, and a network device 1008. As shown, the computer infrastructure may be used in connecting content neural network 1101, user neural network 1102, matchmaking neural network 1103, matchmaking data model 1104, content repository 1105, recommendation engine 1106, API service 1107, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method comprising
processing user data comprised of user feature data as input to a user neural network model and yielding a user embedding;
processing the user embedding through a matchmaking neural network, which is a trained model to map user embeddings and content embeddings to a shared dimensional space, and yielding a user shared-item embedding; and
applying analysis of the user shared-item embedding in selecting at least one content item associated with a content shared-item embedding within the matchmaking neural network.

2. The method of claim 1, wherein applying analysis of the user matchmaking embedding in selecting at least one content item comprises: calculating personalization scores between the user shared-item embedding and content shared-item embeddings of a set of candidate content items; and updating prioritization of the set of candidate content items based in part on calculated personalization scores.

3. The method of claim 2, wherein calculating personalization scores between the user shared-item embedding and content shared-item embeddings of a set of candidate content items comprises, for each content shared-item embedding of the set of candidate content items, calculating a personalization score by calculating a displacement between the user shared-item embedding and a content shared-item embedding.

4. The method of claim 3, wherein the matchmaking neural network is a collaborative metric learning model; and wherein the displacement is the Euclidean distance between the user shared-item embedding to content shared-item embeddings.

5. The method of claim 2, wherein calculating personalization scores between the user shared-item embedding and a content shared-item embedding of the set of candidate content item comprises:
generating a first classifier input by calculating a displacement between the user shared-item embedding and the content shared-item embedding;
generating at least a second classifier input by calculating a set of user-related content displacements between the content shared-item embedding and a set of user-related content shared-item embeddings;
processing the first classifier input and at least the second classifier input within a classifier model and outputting the personalization score.

6. The method of claim 1, wherein applying analysis of the user shared-item embedding comprises:
receiving a query input,
querying a content database to identify a filtered set of candidate content items,
calculating a personalization score between the user shared-item embedding and each content shared-item embedding of the set of candidate content items, and
updating prioritization of the set of candidate content items based in part on the personalization scores.

7. The method of claim 5, wherein applying analysis of the user shared-item embedding further comprises grouping the set of candidate content items into a set of relevancy-groups; and wherein updating prioritization of the set of candidate content items is based in part on the personalization scores comprises reprioritizing the set of candidate content items by using the personalization score to order candidate content items within the same relevancy group.

8. The method of claim 1, wherein applying analysis of the user shared-item embedding comprises:
receiving a query input,
identifying a set of candidate content items,
calculating a personalization score between the user shared-item embedding and each content shared-item embedding of the set of candidate content items, and
updating prioritization of the set of candidate content items based in part on the personalization scores.

9. The method of claim 8, wherein identifying the set of candidate content items comprises identifying a set of shared-item embeddings satisfying a proximity condition relative to an anchor item.

10. The method of claim 1, wherein the content shared-item embeddings are associated with product data records.

11. The method of claim 1, wherein the content shared-item embeddings are associated with digital media content selected from the list of articles, images, video, and audio.

12. The method of claim 1, wherein selecting at least one content item associated with a content shared-item embedding within the matchmaking neural network comprises selecting a promotional content item and serving the promotional content item within a digital advertising network to a user.

13. The method of claim 1, further comprising: training the user neural network; and training the matchmaking neural network by applying collaborative metric learning.

14. The method of claim 16, further comprising training a content neural network; for a set of content items: processing content data comprised of content feature data as input to the content neural network model and yielding a content embedding, and processing the content embedding through the matchmaking neural network, yielding a content shared-item embedding.

15. The method of claim 16, wherein training the user neural network and training the matchmaking neural network comprises: establishing a first set of user feature training data comprised of all user-associated interaction data and establishing a second set of user feature training data comprised of select set of user-associated interaction data, and training the user neural network on the first set of user feature training data and the second set of user feature training data, and training the matchmaking neural network by applying collaborative metric learning on using data derived from the first set of user feature training data and the second set of user feature training data.

16. A non-transitory computer-readable medium storing instructions that, when executed by one or more computer processors of a computing platform, cause a computing platform to perform the operations:
processing user data comprised of user feature data as input to a user neural network model and yielding a user embedding;
processing the user embedding through a matchmaking neural network, which is a trained model to map user embeddings and content embeddings to a shared dimensional space, and yielding a user shared-item embedding; and
applying analysis of the user shared-item embedding in selecting at least one content item associated with a content shared-item embedding within the matchmaking neural network.

17. The non-transitory computer-readable medium of claim 16, further comprising instructions that cause the computing platform to perform the operations:
training the user neural network;
training a content neural network;
training the matchmaking neural network by applying collaborative metric learning;
for a set of content items, processing content data comprised of content feature data as input to the content neural network model and yielding a content embedding, and processing the content embedding through the matchmaking neural network, yielding a content shared-item embedding; and
wherein applying analysis of the user matchmaking embedding in selecting at least one content item comprises: calculating personalization scores between the user shared-item embedding and content shared-item embeddings of a set of candidate content items, and updating prioritization of the set of candidate content items based in part on calculated personalization scores.

18. A system comprising of:
one or more computer-readable mediums storing instructions that, when executed by the one or more computer processors, cause a computing platform to perform operations comprising:
processing user data comprised of user feature data as input to a user neural network model and yielding a user embedding;
processing the user embedding through a matchmaking neural network, which is a trained model to map user embeddings and content embeddings to a shared dimensional space, and yielding a user shared-item embedding; and
applying analysis of the user shared-item embedding in selecting at least one content item associated with a content shared-item embedding within the matchmaking neural network.

19. The system of claim 1, wherein the instructions further cause the computing platform to perform the operations:
training the user neural network;
training a content neural network;
training the matchmaking neural network by applying collaborative metric learning;
for a set of content items, processing content data comprised of content feature data as input to the content neural network model and yielding a content embedding, and processing the content embedding through the matchmaking neural network, yielding a content shared-item embedding; and
wherein applying analysis of the user matchmaking embedding in selecting at least one content item comprises: calculating personalization scores between the user shared-item embedding and content shared-item embeddings of a set of candidate content items, and updating prioritization of the set of candidate content items based in part on calculated personalization scores.
